(19) United States
(12) Patent Application Publication
(10) Pub. No.: US 2018/0357614 A1
(43) Pub. Date: Dec. 13, 2018

(54) System And Method For Detecting Spikes In Automotive Repairs

(71) Applicant: Snap-on Incorporated, Kenosha, WI (US)

(72) Inventors: Patrick S. Merg, Hollister, CA (US); Roy Steven Brozovich, Campbell, CA (US)

(21) Appl. No.: 15/620,029

(22) Filed: Jun. 12, 2017

(51) Int. Cl. G06Q 10/00; G06Q 50/30

(52) U.S. Cl. CPC G06Q 10/20; G06Q 50/30

(57) ABSTRACT

Methods and systems for generating baselines based on vehicle repair orders (VROs) are described. The method includes determining a first set of multiple VROs and a second set of multiple VROs; determining a vehicle service baseline based on a quantity of VROs in the first set including a common vehicle service phrase (VSP); determining a comparison element based on a quantity of VROs in the second set including the common VSP; determining a deviation between the baseline and the comparison element; determining the deviation exceeds a threshold and responsively determining one or more common factors associated with at least a subset of the second set, wherein the one or more common factors are different than the common vehicle descriptor and the common VSP; and outputting a notification indicative of the common vehicle descriptor, the deviation, the common VSP, and the one or more common factors.

### BACKGROUND

Many products produced by manufacturers occasionally have to be repaired. Many owners are unequipped or otherwise unable to repair certain products. Such owners may depend on professional repair technicians to service or repair the owner's product.

The repair technicians typically repair products at a product repair shop. A repair shop has traditionally produced a vehicle repair order (VRO) to capture a variety of information regarding a request for servicing or repairing a product. As an example, the captured information can include information identifying the product, the product's owner, the repair shop, the date of repair, and the type of repair or service needed or performed. The VRO can exist in various formats such as a paper format or an electronic format.

The repair technicians working on different instances of a common product can be located in various locations, such that a first repair technician located at a first location is not aware of a repair made by a second repair technician at a second location. It may be beneficial, if the second repair technician could obtain information regarding the repair made by the first technician.

### OVERVIEW

Example embodiments are described herein. In one respect, one or more example embodiments can be arranged as a method including (i) determining a first set of multiple vehicle repair orders (VROs) and a second set of multiple VROs, where the VROs within the first and second sets are associated with a common vehicle descriptor indicative of a category of vehicles; (ii) determining a vehicle service baseline based on a quantity of VROs in the first set including a common vehicle service phrase (VSP); (iii) determining a comparison element based on a quantity of VROs in the second set including the common VSP; (iv) determining a deviation between the baseline and the comparison element; (v) determining the deviation exceeds a threshold and responsively determining one or more common factors associated with at least a subset of the second set, where the one or more common factors are different than the common vehicle descriptor and the common VSP; and (vi) outputting a notification indicative of the common vehicle descriptor, the deviation, the common VSP, and the one or more common factors.

In another respect, one or more example embodiments can be arranged as a non-transitory computer-readable medium storing: a first set of multiple vehicle repair orders (VROs) and a second set of multiple VROs, where the VROs within the first and second sets are associated with a common vehicle descriptor indicative of a category of vehicles. The non-transitory computer-readable medium also stores program instructions executable by a processor to perform or cause performance of operations including: (i) determining a vehicle service baseline based on a quantity of VROs in the first set including a common vehicle service phrase (VSP); (ii) determining a comparison element based on a quantity of VROs in the second set including the common VSP; (iii) determining a deviation between the baseline and the comparison element; (iv) determining the deviation exceeds a threshold and responsively determining one or more common factors associated with at least a subset of the second set, where the one or more common factors are different than the common vehicle descriptor and the common VSP; and (v) outputting a notification indicative of the common vehicle descriptor, the deviation, the common VSP, and the one or more common factors.

In yet another respect, one or more example embodiments can be arranged as a system including: a processor; and a non-transitory computer-readable data storage device storing a first set of multiple vehicle repair orders (VROs) and a second set of multiple VROs, where the VROs within the first and second sets are associated with a common vehicle descriptor indicative of a category of vehicles, and storing computer-readable program instructions. The computer-readable program instructions are executable by the processor to: (i) determine a vehicle service baseline based on a quantity of VROs in the first set including a common vehicle service phrase (VSP); (ii) determine a comparison element based on a quantity of VROs in the second set including the common VSP; (iii) determine a deviation between the baseline and the comparison element; (iv) determine the deviation exceeds a threshold and responsively determine one or more common factors associated with at least a subset of the second set, where the one or more common factors are different than the common vehicle descriptor and the common VSP; and (v) outputting a notification indicative of the common vehicle descriptor, the deviation, the common VSP, and the one or more common factors.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings, in which:

FIG. 1 is a block diagram of a system in accordance with one or more example embodiments.

FIG. 2 is a block diagram showing details of a repair order system (ROS), according to an example embodiment.

FIG. 3 shows an example repair order, according to an example embodiment.

FIG. 4 is a diagram showing data pertaining to VRO baselines that can be stored within or as baseline data in a data storage device.

FIG. 5 is a flowchart depicting a set of functions that can be carried out in accordance with one or more example embodiments.

FIG. 6 is a graph depicting VRO baselines, according to an example embodiment.

FIGS. 7A, 7B, and 7C illustrate a display device, in accordance with one or more example embodiments.

FIGS. 8A, 8B, 8C, and 8D illustrate a display interface of a display device, according to an exemplary embodiment.

FIG. 9 is a block diagram showing details of example repair shop equipment (RSE), according to an example embodiment.

### DETAILED DESCRIPTION

### I. Introduction

A vehicle repair order (VRO) includes a variety of information regarding a request for servicing or repairing a vehicle. Although the VRO can provide technicians with information about the repair or service of the vehicle, it can be beneficial to technicians to obtain information about the repair or service of many vehicles. Information about the repair of many vehicles can inform technicians of problems that are common amongst many vehicles. In practice, systems can receive VROs that are generated in repair shops, and can provide technicians with information about problems common amongst vehicles that were repaired or serviced in the repair shops. However, these systems do not provide technicians with possible causes or sources of the common vehicle problems.

Disclosed herein is a method and system that can help detect vehicle problems and that can also help determine the cause(s) of the detected problems. This description describes several example embodiments. At least some of those example embodiments pertain to a repair order system (ROS) receiving vehicle repair orders (VRO) from repair shop equipment (RSE) located in repair shops. The ROS can analyze the received VROs to determine vehicle repair data such as repair trends and/or other statistical data describing the vehicle repairs of a vehicle type and/or a vehicle part. The ROS can also determine the repair velocity, and can detect a spike in the repair velocity of the vehicle type and/or a vehicle part. A spike in the repair velocity can be indicative of a problem with the vehicle type and/or vehicle part. And responsive to detecting the spike, the ROS can determine the problem that caused the spike in the repair velocity.

To analyze the received VROs, the ROS can group the VROs based on a common vehicle descriptor. The ROS can then generate (i) a baseline based on a first subset of the grouped VROs that includes VROs generated within a first time period, and (ii) a comparison element based on a second subset of the grouped VROs that includes VROs generated within a second time period. Then, the ROS can compare the comparison element to the baseline to determine whether a deviation exists between the comparison element and the baseline. If the ROS determines a deviation greater than a threshold exists, the ROS can infer that the deviation is indicative of a problem since the deviation can indicate an abnormality in the vehicle repairs represented by the second subset of VROs.

The ROS can further analyze the VROs in the second subset in order to determine a common factor amongst the analyzed VROs. The ROS can use the common factor to determine, amongst other determinations, a cause of the problem that caused the deviation. Subsequently, the ROS can provide a notification to relevant entities. The notification can be indicative of the deviation, any common factors amongst the VROs that are associated with the deviation, and any determinations made based on the common factors (e.g., a cause of the problem that caused the deviation). The entities can then address the cause of the problem that caused the deviation.

In this description, the articles “a” or “an” are used to introduce elements of the example embodiments. The intent of using those articles is that there is one or more of the elements. In this description, the intent of using the term “and/or” within a list of at least two elements or functions and the intent of using the terms “at least one of” and “one or more of” immediately preceding a list of at least two components or functions is to cover each embodiment including a listed component or function independently and each embodiment comprising a combination of the listed components or functions. For example, an embodiment described as comprising “A, B, and/or C,” or “at least one of A, B, and C,” or “one or more of A, B, and C” is intended to cover each of the following possible embodiments: (i) an embodiment comprising A, but not B and not C, (ii) an embodiment comprising B, but not A and not C, (iii) an embodiment comprising C, but not A and not B, (iv) an embodiment comprising A and B, but not C, (v) an embodiment comprising A and C, but not B, (v) an embodiment comprising B and C, but not A, and (vi) an embodiment comprising A, B, and C. For the embodiments comprising component or function A, the embodiments can comprise one A or multiple A. For the embodiments comprising component or function B, the embodiments can comprise one B or multiple B. For the embodiments comprising component or function C, the embodiments can comprise one C or multiple C. The use of ordinal numbers such as “first,” “second,” “third” and so on is to distinguish respective elements rather than to denote a particular order of those elements unless the context of using those terms explicitly indicates otherwise.

The example embodiments are applicable to a variety of repairable items, such as a vehicle or some other type of repairable item. For purposes of this description, a vehicle is a mobile machine that can be used to transport a person, people, or cargo. As an example, any vehicle described herein can be driven or otherwise guided along a path (e.g., a paved road or otherwise) on land, in water, or in the air or outer space. As another example, any vehicle described herein can be wheeled, tracked, railed or skied. As yet another example, any vehicle described herein can include an automobile, a motorcycle, an all-terrain vehicle (ATV) defined by ANSFSVIA-1-2007, a snowmobile, a personal watercraft (e.g., a JET SKI® personal watercraft), a light-duty truck, a medium-duty truck, a heavy-duty truck, a semi-tractor, or a farm machine. As an example, a vehicle guided along a path can include a van (such as a dry or refrigerated van), a tank trailer, a platform trailer, or an automobile carrier. As still yet another example, any vehicle described herein can include or use any appropriate voltage or current source, such as a battery, an alternator, a fuel cell, and the like, providing any appropriate current or voltage, such as about 12 volts, about 42 volts, and the like. As still yet another example, any of the vehicles described herein can include or use any desired system or engine. Those systems or engines can include items that use fossil fuels, such as gasoline, natural gas, propane, and the like, electricity, such as that generated by a battery, magneto, fuel cell, solar cell and the like, wind and hybrids or combinations thereof. As still yet another example, any vehicle discussed herein can include an ECU, a data link connector (DLC), and a vehicle communication link that connects the DLC to the ECU.

A vehicle manufacturer can build various quantities of vehicles each calendar year (i.e., January 1^{st} to December 31^{st}). In some instances, a vehicle manufacturer defines a model year for a particular vehicle model to be built. The model year can start on a date other than January 1^{st} and/or can end on a date other than December 31^{st}. The model year can span portions of two calendar years. A vehicle manufacturer can build one vehicle model or multiple different vehicle models. Two or more different vehicle models built by a vehicle manufacturer during a particular calendar year can have the same of different defined model years. The vehicle manufacturer can build vehicles of a particular vehicle model with different vehicle options. For example, the particular vehicle model can include vehicles with six-cylinder engines and vehicles with eight-cylinder engines. The vehicle manufacturer or another entity can define vehicle identifying information for each vehicle built by the vehicle manufacturer. Vehicle descriptors identify particular sets of vehicles (e.g., all vehicles of a particular vehicle model for a particular vehicle model year or all vehicles of a particular vehicle model for a particular vehicle model year with a particular set of one or more vehicle options). Each particular set of vehicles can be referred to as a “particular category of vehicles” and a “vehicle type.”

As an example, the vehicle descriptor can comprise indicators of characteristics of the vehicle such as when the vehicle was built (e.g., a vehicle model year), who built the vehicle (e.g., a vehicle make (i.e., vehicle manufacturer)), marketing names associated with vehicle (e.g., a vehicle model name, or more simply “model”), and features of the vehicle (e.g., an engine type). In accordance with that example, the vehicle descriptor can be referred to by an abbreviation YMME or Y/M/M/E, where each letter in the order shown represents a model year identifier, vehicle make identifier, vehicle model name identifier, and engine type identifier, respectively, or an abbreviation YMM or Y/M/M, where each letter in the order shown represents a model year identifier, vehicle make identifier, and vehicle model name identifier, respectively. An example Y/M/M/E is 2004/Toyota/Camry/4Cyl, in which “2004” represents the model year the vehicle was built, “Toyota” represents the name of the vehicle manufacturer Toyota Motor Corporation, Aichi Japan, “Camry” represents a vehicle model built by that manufacturer, and “4Cyl” represents a an engine type (i.e., a four cylinder internal combustion engine) within the vehicle. A person skilled in the art will understand that other features in addition to or as an alternative to “engine type” can be used to identify a vehicle using a vehicle descriptor. These other features can be identified in various manners, such as a regular production option (RPO) code, such as the RPO codes defined by the General Motors Company LLC, Detroit Mich.

A vehicle part is a component of a vehicle. Each vehicle comprises multiple vehicle parts. A vehicle part can comprise a single component, such as a bolt, a knob, or a tire. Alternatively, a vehicle part can comprise multiple components, such an engine sub-assembly or a radio having one or more knobs. A vehicle communication link and an ECU are other examples of vehicle parts.

A vehicle communication link within a vehicle can include one or more conductors (e.g., copper wire conductors) or can be wireless. As an example, a vehicle communication link can include one or two conductors for carrying vehicle data messages in accordance with a vehicle data message (VDM) protocol. A VDM protocol can include a Society of Automotive Engineers (SAE) J1850 (PWM or VPW) VDM protocol, an International Organization of Standardization (ISO) 15764-4 controller area network (CAN) VDM protocol, an ISO 9141-2 K-Line VDM protocol, an ISO 14230-4 KWP2000 K-Line VDM protocol, or some other protocol presently defined for performing communications within a vehicle.

An ECU can control various aspects of vehicle operation or components within a vehicle. For example, the ECU can include a powertrain (PT) system ECU, an engine control module (ECM) ECU, a supplemental inflatable restraint (SIR) system (i.e., an air bag system) ECU, an entertainment system ECU, or some other ECU. The ECU can receive inputs (e.g., a sensor input), control output devices (e.g., a solenoid), generate a vehicle data message (VDM) (such as a VDM based on a received input or a controlled output), and set a diagnostic trouble code (DTC) as being active or history for a detected fault or failure condition within a vehicle.

A vehicle repair order (VRO) comprises an archive of information pertaining to at least one vehicle job (or more simply “job”). Each job can be identified on a separate job line of the VRO. A VRO can indicate a job status such as prospective, in process, on hold (after being in process), completed, or come-back. The come-back status can represent a job that was considered to be complete until the vehicle was brought back to the repair shop because the job was not performed to the satisfaction of some person, such as a vehicle owner, or for some other reason. A job line can comprise one or more rows of text. A job line can comprise graphical images such as an outline of a vehicle. The graphical image can be marked to indicate information about a job.

A job identified by a VRO can comprise explicit job information that indicates a particular procedure that is to be performed, is being performed, or was performed to a vehicle, such as rotate vehicle tires, change engine oil, or replace air filter. A job identified by a VRO can comprise implicit job information such as a complaint or symptom that pertains to a vehicle, such as “car does not start,” “check engine light on,” or “oil leaking.” A job with implicit job information can be revised to include explicit job information that identifies a particular procedure performed for the job.

A job identified by a VRO can comprise text representing actual language used by a person requesting performance of the job. Additionally or alternatively, a job identified by a VRO can comprise text based on an interpretation of the language used by the person requesting performance of the job. A person, such as a service advisor, or a computing device can perform the interpretation.

A job identified by a VRO can comprise a job performed by or on behalf of a vehicle repair shop that generates the VRO. For example, the job can be performed by a technician that is employed by the vehicle repair shop. As another example, the job can be performed by a third party (e.g., a vehicle glass specialist) commissioned by the vehicle repair shop to perform the job identified by a VRO.

A VRO can comprise other data within or outside of a job line. The other VRO data can comprise, for example, data classifiable in at least one of the following categories of data: repair shop identification data, vehicle owner identification data, service advisor identification data, vehicle technician identification data, vehicle identification data, repair parts data, specification data, labor data, estimate data, financial data, technician notes regarding a job performed by the technician, or miscellaneous VRO data.

The repair shop identification data can comprise, for example, data indicating a name, a location, a telephone number, a physical address, an e-mail address, or a website URL of a repair shop where performance of the job occurred. The identification data of a person, such as the vehicle owner, service advisor, or technician, can comprise at least a part of the person's name, a numeric identifier, or an alpha-numeric identifier. The vehicle owner identification data can comprise a telephone number, a physical address, or an e-mail address of the vehicle owner. The service advisor or technician identification data can comprise an employee number assigned by the vehicle repair shop.

The vehicle identification data can comprise a vehicle identification number of a particular vehicle or data indicating some other characteristics of the particular vehicle, such as the year, make, and model of the particular vehicle or a number on a license plate attached to the vehicle. The repair parts data can comprise data that indicates, for example, a brand, quantity, amount, or price of a repair part or supply, such as a fluid, used to carry out the job. The specification data can comprise data that indicates, for example, capacities of a particular vehicle or torque specifications for the particular vehicle. The labor data can comprise data that indicates, for example, a labor rate or flagged hours. The labor rate can be associated with the vehicle repair shop or the technician assigned to the job. Flagged hours can indicate actual times when the job was performed, such as 8:15 AM to 8:45 AM.

The estimate data can comprise cost and time estimates for carrying out each job on the VRO. The estimate data can comprise one or more estimates, such as an original estimate and a revised estimate. The financial data can comprise, for example, a financial summary of costs associated with the job(s) indicated on the VRO, labor rate information, or tax information. The miscellaneous VRO data can comprise, for example, a calendar date, an RO number, or a vehicle odometer reading.

A VRO can be archived on a variety of media, such as any of a variety of different types of paper, or within a variety of media, such as any of a variety of different non-transitory computer-readable memories. A VRO stored in a computer-readable memory can comprise metadata that identifies the category of one or more data elements on a VRO.

The data to be archived as part of a VRO can be received in various ways. For example, a service advisor can receive information to archive as part of a VRO during a conversation in person or over the telephone, by an inspection, such as a visual inspection, or in writing. The service advisor can archive the received information by, for example, recording the information on a paper VRO or entering the information into a computing device via a computer input device, such as a keyboard or mouse. The computing device can store the received information within a memory device as part of a VRO.

The information of a VRO can comprise information a computing device receives via a vehicle data message generated by the vehicle. The information within a vehicle data message can, for example, comprise a vehicle identification number, an odometer reading, a diagnostic trouble code, a vehicle measurement performed by a component on a vehicle, or a parameter identifier (PID) and PID value. The vehicle measurement can, for example, comprise a tire pressure measurement or a tire temperature measurement.

The information of a VRO can comprise information a computing device receives via a message generated by a service tool used to perform the job. As an example, the service tool can comprise a wheel alignment machine that generates a message with pre-alignment wheel measurements and post-alignment wheel measurements. As another example, the service tool can comprise a vehicle inspection machine that generates measurements during an inspection of the vehicle as the vehicles passes onto or in proximity of the vehicle inspection machine.

The information of a VRO can comprise information a computing device receives via a phone call. For example, the computing device can receive audio or user selections via a touch-tone selection system during a phone call, convert the received audio and/or user selections into information to be recorded as part of a VRO, and store the information in the memory. The audio or user selections can represent any data described herein as being part of a VRO.

The information of a VRO can comprise information a computing device receives from a remote computing device running an application for inputting VRO information. The remote computing device can comprise a smartphone, tablet device, a desktop or laptop computer or some other computing device. The information received from the remote computing device can comprise any data described herein as being part of a VRO.

The information of a VRO can comprise data indicating performance of a job identified on the VRO is declined or approved. The data indicating declining or approving performance of a job can comprise an electronic signature of a person that declined or approved performance of the job.

A VRO can be revised. For example, a VRO may initially identify a complaint, but not a cause of the complaint or a correction to the vehicle made during performance of a job. After performance of the job, the VRO may be revised to indicate the cause and the complaint. As another example, a VRO generated with an implicit job “oil leaking” can be revised to reflect what job was carried out on a vehicle. For instance, the VRO can be revised to state “oil leaking, looked for engine for oil leaks, replaced main seal.” Moreover, the VRO can be revised based on at least one of a taxonomy or an ontology so that the VRO recites predefined terms and phrases for jobs, vehicle components, vehicle component locations or other information. For example, the initial VRO can be revised to state, “Customer states vehicle is leaking oil. Technician inspected vehicle for oil leaks. Technician removed and replaced rear main bearing engine oil seal. Technician confirmed vehicle is not leaking oil.”

A VRO can include an initial number of job lines. The VRO can be revised to include a different number of job lines. The different number of job lines can be based on a vehicle technician recommending performance of some additional job not listed among the initial number of job lines. The additional job can be identified on a job line added by revising the VRO.

The block diagrams and flow charts shown in the figures are provided merely as examples and are not intended to be limiting. Many of the elements illustrated in the figures or described herein are functional elements that can be implemented as discrete or distributed components or in conjunction with other components, and in any suitable combination and location. Those skilled in the art will appreciate that other arrangements and elements (e.g., machines, interfaces, functions, orders, or groupings of functions) can be used instead. Furthermore, various functions described as being performed by one or more elements can be carried out by a processor executing computer-readable program instructions or by any combination of hardware, firmware, or software.

Although many of the example embodiments are described with respect to a vehicle, the example embodiments can be applicable to other repairable items other than a vehicle. As an example, the other repair items can include home appliances, such as a refrigerator, a dishwasher, or a washing machine, or a consumer electronic device, such as a television, a cellular phone, or a tablet device. Other examples of the repairable items other than a vehicle are also possible.

### II. Example Architecture

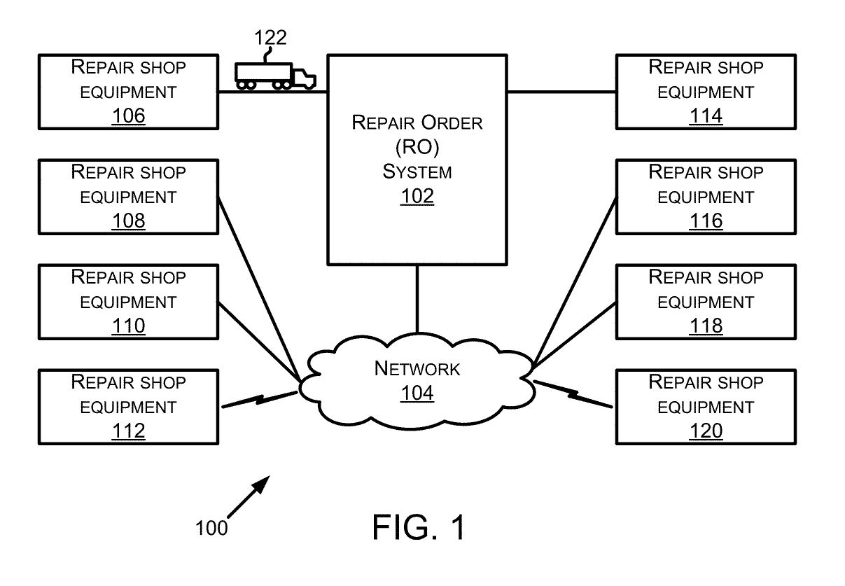

FIG. 1 is a block diagram of a system 100 in accordance with one or more example embodiments. Various combinations of the components shown in FIG. 1 can be arranged as other systems to carry out example embodiments described herein. System 100 includes a repair order system (ROS) 102 and a network 104. The network 104 can include the Internet or a portion thereof, a wireless network, a wired network, a local area network (LAN), or some other type of network. System 100 includes repair shop equipment (RSE) 106, 108, 110, and 112 configured to generate or transmit VROs to ROS 102. The VRO generated by RSE 106 can be provided to an operator of the ROS 102 by a courier 122, such as the United States Postal Service or the Federal Express Corporation. The operator of ROS 102 can enter VROs into the ROS system 102 using a VRO manual entry device. Additionally and/or alternatively, VROs can be digital VROs (e.g., computer-readable VROs) that can automatically be processed by the ROS 102 upon digital receipt of the VROs from one of the RSEs via the network 104.

System 100 includes repair shop equipment (RSE) 114, 116, 118, and 120. The RSE 114, 116, 118, and 120 represent RSE that are configured for performing at least one of the following functions: send VRO data to the ROS 102, request VRO data stored at the ROS 102, receive VRO data transmitted from the ROS 102 using the network 104 or otherwise provided or generated by the ROS 102, present VRO data by a user interface, and receive instructions and/or notifications from the ROS system 200. The functions performed by the RSE 116, 118, and 120 can involve wireless or wired communications using the network 104, as described with respect to the RSE 108, 110, and 112.

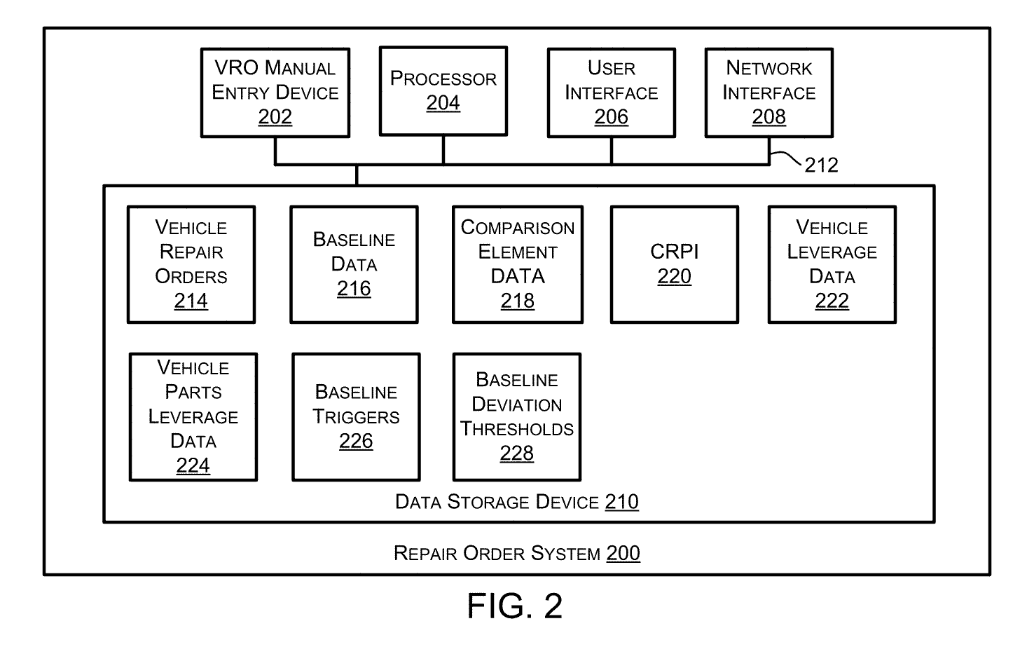

Next, FIG. 2 is a block diagram showing details of a repair order system (ROS) 200. The ROS 102, shown in FIG. 1, can be configured similar to the ROS 200. The ROS 200 can be configured like the ROS 102 shown in FIG. 1.

The ROS 200 includes a VRO manual entry device 202, a processor 204, a user interface 206, a network interface 208, and a data storage device 210, all of which can be linked together via a system bus, network, or other connection mechanism 212.

The VRO manual entry device 202 can include one or more devices for inputting data shown on a printed VRO into the ROS 200 for storage as a VRO within vehicle repair orders (VRO) 214. As an example, the VRO manual entry device 202 can include a scanner device with or without an optical character recognition software application. As another example, the VRO manual entry device 202 can comprise a keyboard for keying in (e.g., typing) and sending the data shown on the printed VRO to processor 204 for storage as a VRO within the VRO 214. As yet another example, the VRO manual entry device 202 can include a device that accepts data storage devices, such as a CD-ROM comprising data representing VRO generated by a repair shop.

A processor, such as the processor 204 or any other processor discussed in this description, can comprise one or more general purpose processors (e.g., INTEL single core microprocessors or INTEL multicore microprocessors) or one or more special purpose processors (e.g., digital signal processors). The processor 204 can be configured to execute computer-readable program instructions, such as computer-readable program instructions (CRPI) 220. For purposes of this description, the processor 204 executing the CRPI 220 to perform some function described herein can comprise executing a portion of the CRPI 220 or the entirety of the CRPI 220. Executing a portion or the entirety of the CRPI 220 can include executing some of the computer-readable program instructions multiple times.

The user interface 206 can comprise an interface to components operable to enter data or information into the ROS 200 or to components that can present data or information output by the ROS 200. Those components can be referred to as user interface components. The user interface 206 can include one or more audio/visual ports or communication ports that connect to a user interface component by a wired or wireless user interface communication link.

The user interface 206 can include one or more of the user interface components. As an example, the user interface components can include an infrared remote control device, a display device, a loud speaker configured to convert electrical signals to audible sounds, a keyboard, a touch screen, a pointing device, such as a computer mouse, or some other component for generating signals to enter data or information into the ROS 200 or to present data or information output by the user interface 206. The user interface 206 can include a transmitter or transceiver to provide the data or information to another user interface component. The data or information provided by the user interface 206 can include a notification identifying a deviation in VRO data detected by the processor 204.

The network interface 208 can comprise an interface to one or more communication networks, such as the network 104. For use with wireless communication networks, the network interface 208 can comprise one or more antennas for transmitting or receiving wireless communications. The network interface 208 can include one or more communication ports configured to connect to a wired communication link of a network, such as a coaxial cable, an Ethernet cable, a fiber optic cable, a digital subscriber line (DSL), a telephone line of a public switched telephone network (PSTN) or some other wired connector. The network interface 208 can include a network controller including a transmitter, a receiver, or a transceiver. The transmitter or transceiver can provide data or information to a communication port for transmission as network communications over the connected network. The receiver or transceiver can receive data or information received at a communication port from the connected network. The data or information provided by the network interface 208 can include communications between the ROS 200 and an RSE.

A data storage device, such as the data storage device 210 or any other data storage device discussed in this description, can comprise one or more data storage devices. A data storage device can comprise a non-transitory data storage device, a transitory data storage device, or both a non-transitory data storage device and a transitory data storage device. A non-transitory data storage device, or a portion thereof, can be located within or as part of a processor (e.g., within a single integrated circuit chip). A non-transitory data storage device, or a portion thereof, can be separate and distinct from a processor.

A non-transitory data storage device can include a volatile or non-volatile storage component, such as an optical, magnetic, organic or other memory or disc storage component. Additionally or alternatively, a non-transitory data storage device can include or be configured as a random-access memory (RAM), a read-only memory (ROM), a programmable read-only memory (PROM), an erasable programmable read-only memory (EPROM), an electrically erasable programmable read-only memory (EEPROM), or a compact disk read-only memory (CD-ROM). The RAM can include static RAM or dynamic RAM.

A transitory data storage device can include, for example, CRPI provided over a communication link, such as a communication link which is connected to or is part of the network 104. The communication link can include a digital or analog communication link. The communication link can include a wired communication link including one or more wires or conductors, or a wireless communication link including an air interface.

A “data storage device” can be referred to by other terms such as a “memory,” a “computer-readable memory,” a “computer-readable medium,” a “computer-readable storage medium,” a “memory device,” “computer-readable media,” a “computer-readable database,” “at least one computer-readable medium,” or “one or more computer-readable medium.” Any of those alternative terms can be preceded by the prefix “transitory” if the memory is transitory or “non-transitory” if the memory is non-transitory. The data storage device 210 can store a variety of data. As shown in FIG. 2, data storage device 210 can store vehicle repair orders (VRO) 214, baseline data 216, comparison element data 218 computer-readable program instructions (CRPI) 220, vehicle leverage data 222, vehicle parts leverage data 224, baseline triggers 226, and baseline deviation thresholds 228.

The VRO 214 can comprise a computer-readable VRO. The computer-readable VRO can be arranged as a structured query language (SQL) file, an extensible markup language (XML) file, or some other type of computer-readable file or data structure. The VRO within VRO 214 can be received from VRO manual entry device 202, from network interface 208 by way of network 104, or from another device.

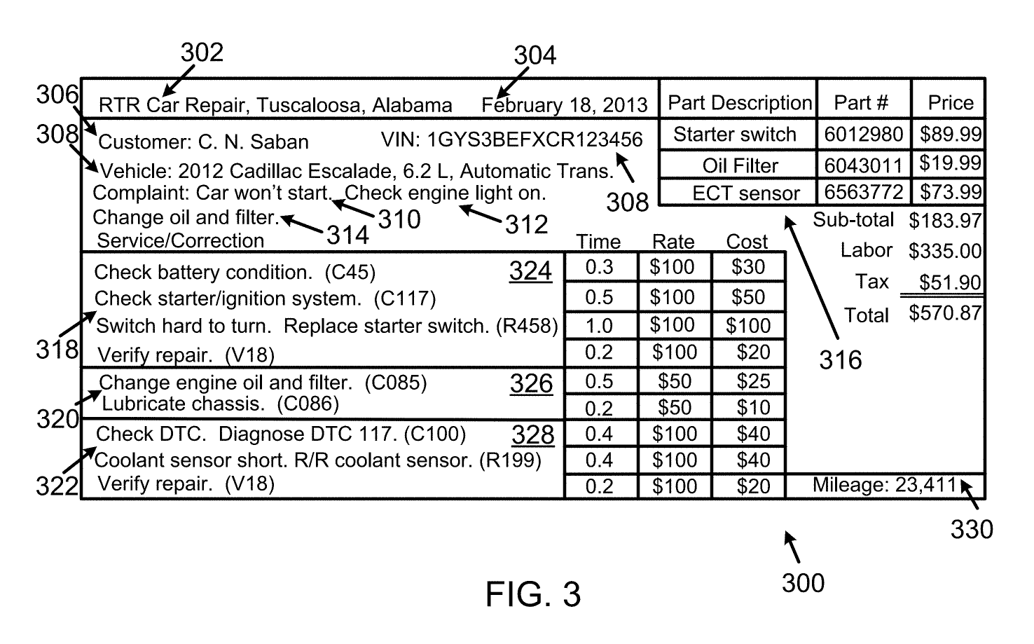

FIG. 3 shows an example VRO 300. VRO 300 can be generated by repair shop equipment, such as any of the RSE shown in FIG. 1. If generated by the RSE 108, 110, or 112, the VRO 300 can comprise a computer-readable VRO transmitted over network 104.

The VRO 300 can include a service provider identifier 302, a date of service identifier 304, a customer indicator 306 that indicates a customer seeking service of a given vehicle, vehicle information 308 that indicates the given vehicle. The VRO 300 can also include vehicle service phrases (VSP) that indicate a complaint of a vehicle problem. VSPs can also indicate the cause of the vehicle problem and/or a correction of that vehicle problem as well or instead of the complaint. The same VSP listed on multiple VROs or on different parts of a common VRO is a common VSP. As an example, a VSP can include a VSP such as (i) “engine stalls on hard acceleration,” (ii) “engine hard start on cold days,” (iii) “brakes squeal when turning,” (iv) “car bottoms out on bumps,” or (v) “exhaust smells like rotten eggs.” Other examples of VSPs include vehicle service requests (VSR) 310, 312, and 314 that indicate the complaint(s) or service(s) requested by the customer, parts information 316 indicate vehicle parts obtained for servicing the given vehicle, service procedure information 318, 320, and 322 carried out on the given vehicle. The VRO 300 can also include vehicle mileage data 330.

The service provider identifier 302 can include information that indicates a name and geographic location of the service provider. The vehicle information 308 can include a vehicle identification number (VIN) associated with the given vehicle and a vehicle descriptor. The vehicle descriptor can be indicative of a vehicle model, a vehicle mileage range, a vehicle manufacturer, a vehicle model year, and/or a vehicle propulsion system. The service procedure information 318, 320, and 322 can include information within distinct sections 324, 326, and 328, respectively, of the VRO 300. The service procedure information within any one distinct section 324, 326, and 328 can be unrelated to the service procedure information with any other distinct section. Alternatively, two or more distinct sections including service procedure information can pertain to related service operations performed on the given vehicle.

Some VROs stored within the VRO 214 can be arranged in a configuration that differs from the VRO 300. Nevertheless, the VRO arranged in another configuration typically includes at least one of the types of information described above as being a part of the VRO 300.

The VRO stored within VRO 214 can comprise searchable text or symbols (e.g., text, symbols, or text and symbols). As an example, a symbol on a VRO can comprise an empty check box or a checkbox and a checkmark inside the checkbox.

The VRO 300 includes labor operation codes (LOC). The labor operation codes can conform to those defined by a vehicle manufacturer, a service provider that generates a VRO, a service information provider, such as Mitchell Repair Information, LLC, Poway, Calif., or some other entity. For simplicity of FIG. 3, the labor operation codes are shown within parenthesis, such as (C45) and (C117). Each LOC can refer to a particular operation performed to the given vehicle. The processor 204, executing the CRPI 220, can use a LOC to determine what type of operation was performed to the given vehicle. Using the LOC in that manner is helpful if other information regarding that operation is incomplete or described using non-standard phrases or terms. The processor 204 can also use LOC to determine context for a service line of the VRO.

Multiple portions of text on a VRO can be grouped as phrases. When comparing contents of a VRO to various terms, such as mapping terms, standard terms, or context terms, words within a given proximity to one or more other words can be grouped as a phrase to be compared to the mapping, standard, or context terms. The given proximity can be within X words, where X equals 1, 2, 3, 4, 5, or some other number of words. As an example, the service procedure information 318 states “Check starter/ignition system.” The words “Check” and “ignition system” are within 3 words of one another. In accordance with an embodiment in which the given proximity is greater than 1 word, the words “Check” and “ignition system” can be grouped as the phrase “Check ignition system” for comparison to mapping, standard, context terms, or labor operation codes.

The mapping, standard, context terms, or labor operation codes can be a part of a taxonomy database stored within the data storage device 210 or other computer-readable data storage. The taxonomy database can include data that identifies words or phrases that are associated with one another. The association can be based on the words or phrases having a common meaning. The words or phrases identified as being associated with one another can be referred to a “taxonomy database group” or, more simply, a “taxonomy group.”

The taxonomy database can include one or more taxonomy groups, and each taxonomy group can include one or more words or phrases. As an example, the taxonomy database can include data that identifies the following phrases as a taxonomy group: (i) stalls when cold, (ii) engine quits when temperature is low, (iii) engine dies in the morning, (iv) dies in the morning, (v) dies in the AM, and (vi) engine stalls on cold mornings. Each taxonomy group can be associated with a standard term, which could be a first word or first phrase added to the taxonomy group. Alternatively, a word or phrase subsequently added to the taxonomy group can be the standard term for the taxonomy group. The words or phrases other than the standard term can be mapping terms. The words or phrases within each taxonomy group can be obtained from a VRO. An administrator can approve adding or modifying any taxonomy group.

The processor 204 can also modify the VRO 300 to generate a simplified VRO that can be searched more quickly than the VRO 300. For instance, the processor 204 can remove portions of the information included in the VRO 300, such as the customer indicator 306. In another instance, the processor 204 can modify the VRO 300 by replacing a portion of the text of the VRO 300 with standard terms. For example, the standard terms can be terms that are designated as preferred terms of a taxonomy group. As such, the processor 204 can process the VRO 300 by comparing the text used in the VRO 300 to the preferred term/phrase of the respective taxonomy group of the text. The processor 204 can map the relevant text used in the VRO 300 to a corresponding preferred repair order term. The processor 204 can then generate a modified VRO 300 that replaces the text in the VRO 300 with preferred terms and/or phrases. Generating a modified version (e.g., a standardized version) of the VRO 300 can help in optimizing the operation of processing the data included in the VRO 300. As explained below, processing the data of the VRO 300 can be used in tracking the repair of a vehicle type and/or a vehicle part.

Returning to FIG. 2, the CRPI 220 can comprise any of a variety of program instructions executable by the processor 204 to carry out functions described herein or performable by the ROS 200. The CRPI 220 can comprise program instructions that are executable to parse data from the repair order of the VRO 214 and to identify the VSPs, vehicle descriptors, and other information from each VRO. The VRO data that ROS 200 can parse from a VRO of the VRO 214 includes computer-readable data that indicates VSPs, vehicle descriptors, and other information within the VRO. Furthermore, the CRPI 220 can comprise program instructions that are executable to associate a VRO with data stored in the data storage device 210 or data retrieved from a server via the network interface 208. A VRO can be associated with a vehicle leverage data identifier that is associated with a vehicle identified on a VRO or a vehicle parts leverage data identifier that is associated with a vehicle part identified on a VRO. Additionally, a VRO can be associated with third-party data, such as weather information that can indicate the weather in the geographic area in which the vehicle repair (that the VRO describes) was performed. Other third-party data includes geographic information, fuel supplier information, vehicle parts supplier information, etc.

The vehicle leverage data 222 can comprise computer-readable data that identifies different vehicle models built on a common vehicle platform. Vehicles built on a common vehicle platform can have many similarities including the use of common parts or part numbers. Vehicles built on a common platform can experience similar vehicle symptoms that arise for similar reasons, such as failure of a part common to vehicles built on the common vehicle platform. Vehicle leverage data can be important when new vehicles are introduced into the market. By associating the new vehicle with older vehicles that are built on a common vehicle platform, vehicle repair data that is generated based on the VROs of older vehicles can be used to proactively fix any potential issues with the new vehicle. Table 1 shows an example of data that can be stored as the vehicle leverage data 222.

TABLE 1

| Vehicle | | | |
|---|---|---|---|
| Leverage | | | |
| Data | | | |
| Identifier | | Model | |
| (VLD ID) | Vehicle Models | Year(s) | Exceptions |
| VLD-1 | Cadillac Escalade, | 2011-2013 | GMC Yukon uses |
| | Chevrolet Tahoe, Chevrolet | | hi-capacity radiator |
| | Suburban, GMC Yukon | | |
| VLD-2 | Chevrolet Lumina APV, | 1990-1996 | N.A. |
| | Pontiac Trans Sport, | | |
| | Oldsmobile Silhouette | | |
| VLD-3 | Buick Regal, Oldsmobile | 1998-2002 | N.A. |
| | Intrigue | | |
| VLD-4 | Ford Expedition, Lincoln | 2008-2014 | Lincoln Navigator |
| | Navigator | | uses aluminum |
| | | | cylinder heads |

The processor 204 could use the exception data within the vehicle leverage data to exclude certain vehicle models from a group of vehicles built on a common platform for some or all VRO data. For the exception data in Table 1, since the GMC Yukon uses a different radiator than the Cadillac Escalade, the Chevrolet Tahoe, and the Chevrolet Suburban, VRO data pertaining to a radiator for a GMC Yukon may not be grouped with VRO data pertaining to a radiator on Cadillac Escalades, Chevrolet Tahoes, and Chevrolet Suburbans.

The vehicle parts leverage data 224 can comprise data that identifies different vehicle models that use a common vehicle part produced by a vehicle part(s) manufacturer. For purposes of this description, a common vehicle part is a vehicle part that can be used in either of two or more vehicle models without altering the vehicle part or any of the two or more vehicles to use the common vehicle part. Various references to a common vehicle part, such as a vehicle part number or vehicle part name, used by any or all of the vehicle part(s) manufacturer and the manufacturer(s) of the different vehicle models can be used. Vehicle models using a common vehicle part can experience similar vehicle symptoms that arise for similar reasons, such as failure of the common vehicle part. Table 2 shows an example of data that can be stored as vehicle parts leverage data 224.

TABLE 2

| Common | | | | |
|---|---|---|---|---|
| Vehicle | | | | |
| Part | Common | Vehicle | Model | Vehicle Part(s) |
| Identifier | Vehicle Part | Models | Year(s) | manufacturer |
| PLD-1 | Coolant | Cadillac | 2012 | Delco Parts, Inc. |
| | temperature | Escalade | | |
| | sensor | | | |
| PLD-1 | Coolant | Chevrolet | 2012 | Delco Parts, Inc. |
| | temperature | Tahoe | | |
| | sensor | | | |
| PLD-1 | Coolant | Chevrolet | 2012 | Delco Parts, Inc. |
| | temperature | Suburban | | |
| | sensor | | | |
| PLD-2 | Fuel injector(s) | Honda | 2013 | ACME, Inc. |
| | Accord | | | |
| PLD-2 | Fuel injector(s) | Honda | 2013 | ACME, Inc. |
| | Civic | | | |

The baseline triggers 226 comprise data indicating trigger points for establishing a baseline within the baseline data 216. The data representing the trigger points can be called triggers. In one respect, some or all of the trigger(s) within the baseline triggers 226 can be based on time. For example, time-based triggers can include triggers of 7 days, 30 days, 180 days, 365 days, or some other number of days. Those and other time-based triggers can be represented using other units of time, such as hours, minutes, second, etcetera.

The processor 204 can execute the CRPI 220 to track an amount of time for comparison to a trigger. The processor 204 can start tracking the amount of time in response to detecting any of a variety of events. As an example, the event that causes tracking an amount of time can include receiving a VRO with a new VSP. A time associated with the event that causes tracking the amount of time can be stored as part of a VRO record.

The processor 204 can execute the CRPI 220 to determine that a baseline trigger has been reached. For example, 168 hours (i.e., the number of hours in 7 days) after a new type of VSR record is produced for or within the VRO data 218, the processor 204 can determine that the 7-day baseline trigger has been reached for the new type of VSP record and responsively generate a 7-day VRO baseline based on the VRO data 218 and the new type of VSP record. As another example, 552 hours (i.e., the number of hours in 23 days) after the 7-day baseline trigger is reached, the processor 204 can determine that the 30-day baseline trigger has been reached for the new type of VSP record and responsively generate a 30-day VRO baseline based on the VRO data 218 and the new type of VRO record.

In another respect, some or all of the trigger(s) within the baseline triggers 226 can be based on a number of vehicles serviced or a number of VROs within the VRO 214. As an example, the number of vehicles serviced and the number of VROs can be 1,000 or some other number(s). A trigger based on the number of vehicles or VROs could be limited to vehicles or VROs associated with a common vehicle identifier. In that way, instead of the trigger being for every 1,000 vehicles serviced, where the vehicles can be any make or model, the trigger can be for 1,000 vehicles having a common vehicle identifier being serviced. A count of vehicles or VROs can begin when the ROS 200 detects a first vehicle having the common vehicle identification being serviced or a VRO for that first vehicle being serviced. A trigger based on the number of vehicles or VROs could also be limited to vehicles or VROs associated with a particular geographic location and/or a time period.

In yet another respect, the processor 204 can periodically generate a baseline. For example, the processor 204 can generate a baseline in response to a predetermined amount of time elapsing since the last calculated baseline. The periodicity of generating baselines can be on any scale of time, such as generating a baseline every hour, day, week (7 days), month (30 days), year (365 days), etc. At each period, the processor 204 can generate a new baseline that includes any VROs received since the last period, and therefore the new baseline generated at each period can be more accurate than the previously generated baselines since the new baseline is based on a greater number of VROs.

The baseline data 216 can comprise computer-readable data stored as one or more VRO baselines. The processor 204 can execute the CRPI 220 to determine one or more VRO baselines stored in baseline data 216. One or more of the VSR baselines stored within baseline data 216 can comprise a VSR baseline entered by user interface 206 or received by network interface 208.

The comparison element data 218 can also comprise computer-readable data stored as one or more VRO comparison elements. The processor 204 can execute the CRPI 220 to determine a comparison element stored in comparison element 228.

The baseline deviation thresholds 228 can comprise computer-readable data that identifies one or more thresholds for the processor 204 determining a deviation of a comparison element within comparison element data 218 with respect to a baseline within baseline data 216. As an example, a baseline deviation threshold can comprise or represent a number, such as twenty-five [25]. The number can represent a percentage, such as 25%, or a decimal, such as 0.25. Further, a threshold can be associated with a particular type of analysis performed.

The processor 204 can execute the CRPI 220 to determine if the comparison element exceeds the baseline by at least the percentage represented by the baseline deviation threshold. If the baseline deviation threshold is exceeded, processor 204 detects a first deviation, otherwise, processor 204 can determine that a deviation does not exist with respect to the VRO data used to determine the VRO baseline.

Additionally or alternatively, the processor 204 can execute CRPI 220 to determine if the VRO baseline exceeds the comparison element by at least the percentage represented by the baseline deviation threshold. If the baseline deviation threshold is exceeded in this arrangement, the processor 204 detects a first deviation, otherwise, the processor 204 can determine that a deviation does not exist with respect the VRO data used to determine the VRO baseline.

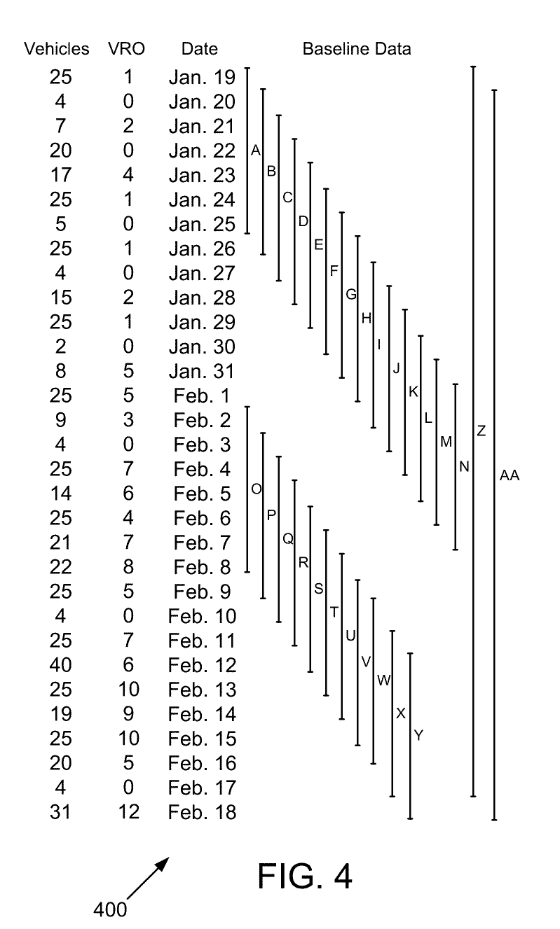

FIG. 4 is a diagram 400 showing data pertaining to VRO baselines that can be stored within or as baseline data 216. The lines labeled as A through Z and AA represent various VRO baselines. For purposes of this description, those lines will hereinafter be referred to as VRO baselines A through Z and AA, respectively. VRO baselines A through Y are 7-day VRO baselines. VRO baselines Z and AA are 30-day VSR baselines. The calendar dates shown on FIG. 4 can be for the calendar year 2016.

The VRO baselines A through Z and AA can be for an example vehicle type, such as the vehicle type identified on the VRO 300: Model Year (2012), Make (Cadillac), Model (Escalade). The example vehicle type is not limited to a single model year, make, or model. In accordance with vehicle leverage data 222, the example vehicle type for VRO baselines A through Z and AA can include 2011-2016 Cadillac Escalades, 2011-2016 Chevrolet Tahoes, 2011-2016 Chevrolet Suburbans, and 2011-2016 GMC Yukons. By referring to VSPs and other data pertaining to the vehicles in addition to the model year 2012 Cadillac Escalade, the processor 204 can find a larger sample of VROs than if only the VSP for the model year 2012 Cadillac Escalade are referenced.

In addition to the example vehicle type, each VRO represented in FIG. 4 can pertain to a common vehicle service phrase (VSP) such as a common complaint, cause, or correction taken in response to the common complaint. The number of VROs represented on FIG. 4 can indicate, for each date shown on FIG. 4, a number of VROs for diagnosing a complaint of a check engine light being on within a vehicle represented by the VLD-1 identifier shown in Table 1, a diagnostic trouble code (DTC) 117 being set within the vehicle represented by the VLD-1 identifier shown in Table 1, and an engine coolant temperature (ECT) sensor being replaced within the vehicle represented by the VLD-1 identifier shown in Table 1.

The number of vehicles listed by each date can refer to the number of vehicles of the example vehicle type serviced on that date or the number of VROs within the VRO 214 for the example vehicle type on the service date. Based on the foregoing description and FIG. 4, the VRO 214 can include 25 VRO for the example vehicle type and 1 of the 25 VRO can include the common VSP relating to VSP 312 and the service procedure information 322.

The VRO baselines within baseline data 216 can comprise or be represented by a ratio. For example, VRO baseline A can be a ratio of the quantity of VROs associated with the common VSP occurring on dates January 19 through January 25, inclusive, divided by the number of vehicles of the example vehicle type serviced on those same dates (i.e., 103 vehicles). According to that example, VRO baseline A is 0.08 (i.e., 8 divided by 103). Table 3 shows VRO baseline values based on FIG. 4.

TABLE 3

| | | | | VRO Baseline |
|---|---|---|---|---|
| VRO | VRO | | | Value: VRO |
| Baseline | Baseline | VRO | No. of | Quantity/No. |
| ID | Type | Quantity | Vehicles | of Vehicles |
| A | 7-Day | 8 | 103 | 0.08 |
| B | 7-Day | 8 | 103 | 0.08 |
| C | 7-Day | 8 | 103 | 0.08 |
| D | 7-Day | 8 | 111 | 0.07 |
| E | 7-Day | 9 | 116 | 0.08 |
| F | 7-Day | 5 | 101 | 0.05 |
| G | 7-Day | 9 | 104 | 0.09 |
| H | 7-Day | 14 | 88 | 0.16 |
| I | 7-Day | 16 | 88 | 0.18 |
| J | 7-Day | 16 | 98 | 0.16 |
| K | 7-Day | 21 | 87 | 0.24 |
| L | 7-Day | 26 | 110 | 0.24 |
| M | 7-Day | 30 | 123 | 0.24 |
| N | 7-Day | 32 | 120 | 0.27 |
| O | 7-Day | 35 | 136 | 0.26 |
| P | 7-Day | 37 | 136 | 0.27 |
| Q | 7-Day | 37 | 136 | 0.27 |
| R | 7-Day | 37 | 162 | 0.23 |
| S | 7-Day | 37 | 162 | 0.23 |
| T | 7-Day | 43 | 160 | 0.27 |
| U | 7-Day | 45 | 163 | 0.28 |
| V | 7-Day | 47 | 158 | 0.29 |
| W | 7-Day | 47 | 158 | 0.29 |
| X | 7-Day | 47 | 158 | 0.29 |
| Y | 7-Day | 52 | 164 | 0.31 |
| Z | 30-Day | 109 | 514 | 0.21 |
| AA | 30-Day | 120 | 520 | 0.23 |

FIG. 4 and Table 3 show that each 7-day VRO baseline is limited to a single 7 day period. In accordance with one or more example embodiments, a 7-day VRO baseline can be an aggregate of multiple 7-day periods, such as the multiple 7-day periods starting January 19 through January 25, inclusive, (i.e., the 7-day periods for VSR baselines A through F, inclusive). An average VRO quantity for those 6 days is 7.7 VROs/day (i.e., 46 VROs divided by 6 days). An average number of vehicles for those 6 days is 106.1 vehicles/day (i.e., 637 vehicles divided by 6 days). Those two averages provide for an aggregate VRO baseline value of 0.07 (i.e., 7.7 VROs/day divided by 106.1 vehicles/day).

The VRO data collected from the VROs of January 19 through January 25, inclusive, for VRO baseline A can be the initial or first VRO data for a 7-day baseline. The VRO data collected from the VROs of January 19 through February 17, inclusive, for VRO baseline Z can be the initial or the first VRO data for a 30-day baseline.

### III. Example Operation

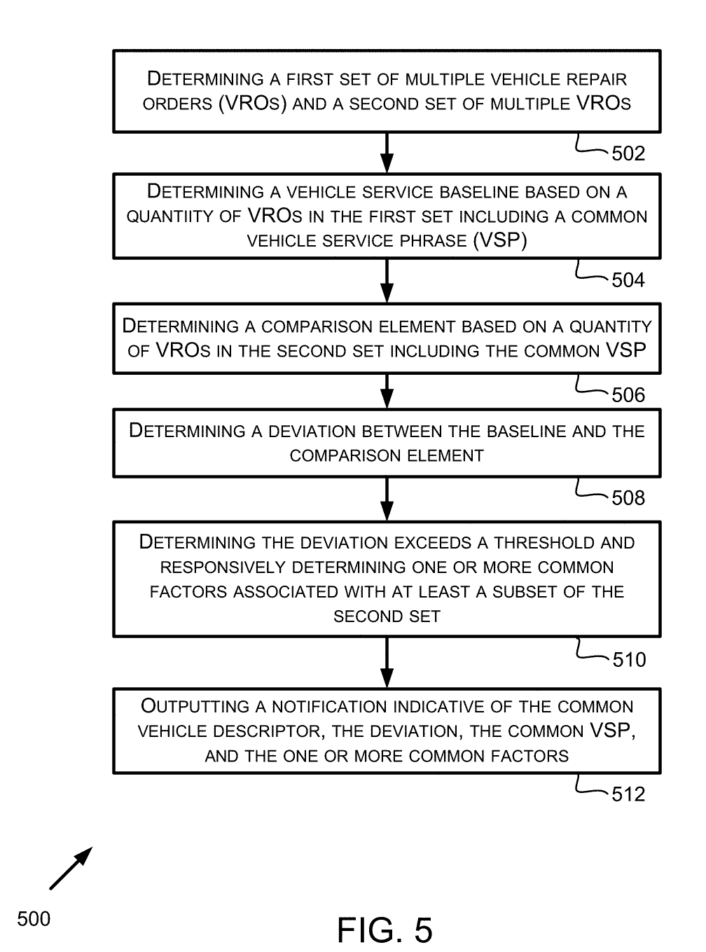

FIG. 5 is a flowchart illustrating a vehicle repair tracking method 500, according to an example implementation. The method 500 shown in FIG. 5 (and other processes and methods disclosed herein) presents a method that can be implemented within an arrangement including, for example, system 100, ROS system 200, and/or RSE 900 (or more particularly by one or more components or subsystems thereof, such as by a processor and a (e.g., non-transitory or transitory) computer-readable medium having instructions that are executable to cause the device to perform functions described herein). Additionally or alternatively, the method 500 can be implemented within any other arrangements and systems.

The method 500 and other processes and methods disclosed herein can include one or more operations, functions, or actions as illustrated by one or more of blocks 502-512. Although the blocks are illustrated in sequential order, these blocks can also be performed in parallel, and/or in a different order than those described herein. Also, the various blocks can be combined into fewer blocks, divided into additional blocks, and/or removed based upon the desired implementation.

In addition, for the method 500 and other processes and methods disclosed herein, the method 500 shows functionality and operation of one possible implementation of present implementations. In this regard, each block can represent a module, a segment, or a portion of program code, which includes one or more instructions executable by a processor for implementing specific logical functions or steps in the process. The program code can be stored on any type of computer-readable medium, for example, such as a data storage device including a disk or hard drive. The computer readable medium can include non-transitory computer-readable medium, for example, such as computer-readable media that stores data for short periods of time like register memory, processor cache and Random Access Memory (RAM). The computer-readable medium can also include non-transitory media, such as secondary or persistent long term storage, like read only memory (ROM), optical or magnetic disks, compact-disc read only memory (CD-ROM), for example. The computer-readable media can also be any other volatile or non-volatile storage systems. The computer-readable medium can be considered a computer readable storage medium, for example, or a tangible storage device. In addition, for the method 500 and other processes and methods disclosed herein, each block in FIG. 5 can represent circuitry that is wired to perform the specific logical functions in the process.

The following description of the method 500 includes references to elements shown in other figures described in this description, but the functions of the method 500 are not limited to being carried out only by the referenced elements. A variety of methods can be performed using all of the functions shown in FIG. 5 or any proper subset of the functions shown in FIG. 5. Any of those methods can be performed with other functions such as one or more of the other functions described in this description. One or more of the functions shown in FIG. 5 can be carried out multiple times in performing a method in accordance with the example embodiments.

At block 502, the method 500 includes determining a first set of multiple VROs and a second set of multiple VROs. In an embodiment, the processor 204 can determine a set of VROs (also referred to herein as a “VRO set”) by selecting VROs (e.g., from the VROs 214) that are associated with one or more common characteristics. By way of example, the processor 204 can determine a set of VROs by selecting VROs that are associated with a common vehicle descriptor, a common time period, and/or a common geographic area. The one or more characteristics can be selected by an operator of the ROS 200 or can autonomously be selected by the ROS 200.

As explained above a vehicle descriptor can include data that identifies a vehicle, such as vehicle leverage data (e.g., vehicle leverage data 222), data indicative of a vehicle model, a vehicle mileage range, a vehicle manufacturer, a vehicle model year, a vehicle propulsion system, etc. For instance, the vehicle descriptor may be indicative of vehicles that have the same transmission, same engine, and/or same YMME. And a time period can be indicative of a span of time during which a set VRO was generated (i.e., the time and/or date of repair). For instance, a time period can be indicative of a period of time between two points in time and/or between two dates (inclusive). A geographic area can be indicative of a geographical area in which the repair shop that generated a set VROs is located. For instance, the geographical area may be a county. Note that the geographical area does not only include officially defined areas (e.g., cities, counties, states, etc.) but may also include areas that are smaller than or larger than the officially defined areas. For instance, the geographical area may be an area within a county or may be an area that spans several counties.

Within examples, the common characteristics that are used to generate the first set of VROs set may depend on a user input that indicates desired common characteristics. For instance, the user could provide an input that triggers generating VRO sets associated with a particular vehicle located in a particular area during a particular time period. In a first example, the user could indicate that the common characteristics are (i) 2004 Toyota Camrys, (ii) serviced during January 2015, and (iii) located in Chicago. In a second example, the user could indicate that the common characteristics are (i) vehicles, (ii) serviced during the past six months, and (iii) located in California. Accordingly, in the second example, the generated VRO set includes all vehicles that were serviced in the past six months in the state of California.

Additionally and/or alternatively, the processor 204 can determine the first set of multiple VROs by selecting VROs that are associated with a common vehicle descriptor, a first period of time, and/or a first geographic region. For example, the processor 204 can select VROs that are associated with (i) a vehicle descriptor “2004/Toyota/Camry,” (ii) a time period that spans the month of January in the year 2015, and (iii) the city of Chicago. As such, the first set of VROs can include VROs associated with 2004 Toyota Camrys that were serviced during January 2015 in repair shops located in Chicago.

In an embodiment, the processor 204 can be programmed to select specific common characteristics to generate the first set VROs. For example, the processor 204 can be programmed to select common characteristics that are of interest to the user. For example, the user may be a manufacturer or technician of a particular vehicle type. Accordingly, the processor 204 can be programmed to select common factors indicative of the particular vehicle type. Other methods of selecting the common characteristics are possible. For instance, the processor 204 can be programmed to periodically select certain common factors. In another instance, the processor 204 can be programmed to select the most frequently occurring common characteristics in the data.

Similarly, the processor 204 can determine the second set of multiple VROs by selecting VROs that are associated with the common vehicle descriptor (i.e., that was used to generate the first set of multiple VROs), a second time period, and/or a second geographic area. In some examples, the first time period and the second time period can have equivalent lengths, and/or the first geographic area and the second geographic area can be identical. In other examples, the respective time periods of the first set of VROs and the second set of VROs set can overlap but may not be identical, and the respective geographic areas can be different geographic areas that have similar areas and/or populations. In this example, the processor 204 can select VROs that are associated with (i) a vehicle descriptor “2004/Toyota/Camry,” (ii) a time period that spans the month of January in the year 2016, and (iii) the city of Chicago. As such, the second set of multiple VROs includes VROs that are associated with 2004 Toyota Camrys that were serviced during January 2016 in repair shops located in Chicago.

At block 504, the method 500 includes determining a vehicle service baseline based on a quantity of VROs in the first set including a common vehicle service phrase (VSP). In particular, the processor 204 can analyze the VROs in the first set in order to determine a common VSP amongst a plurality of VROs in the first set. The common VSP can comprise any example VSP discussed in this description or a different common VSP as well or instead. In particular, the common VSP may be a symptomatology code, which is any code that indicates a vehicle system (e.g., can be one or both of an LOC and a DTC). The common VSP may also be a complaint, a part repaired or replaced, or a symptomatology phrase (i.e., any phrase in the VRO that includes symptomatology code). In some examples, the common VSP is selected from data that is included in a specific section of the VROs. For example, the common VSP may be determined from the complaints or parts section of the VRO. In some examples, the processor 204 can detect more than one common VSP in the set. In such examples, the processor 204 can select one of the common VSPs to calculate the vehicle service baseline. For instance, the processor 204 can select the VSP that is from specific section of the VRO (e.g., complaints section).

For example, the processor 204 can determine that a plurality of VROs in the first set are associated with a common cause of a vehicle problem, e.g., bad fuel was the cause of a faulty fuel injector. That is, each of a plurality of VROs in the first set is indicative of a repair of a fuel injector of a car where it was determined that the cause of the fuel injector malfunction was that the car was filled with bad fuel. The processor 204 can then determine the baseline based on a quantity of the plurality of VROs in the first set associated with the common VSP.

In a first embodiment, the baseline can be a ratio of the quantity of VROs in the first set associated with the common VSP to an estimate count of vehicles associated with the common vehicle descriptor that are located in the first geographic area during the first time period. Consider, for example, the first set described above, which includes VROs associated with 2004 Toyota Camrys that were serviced during January 2015 in repair shops located in Chicago. The processor 204 can determine that a plurality of VROs in the first set are associated with a common cause of a vehicle problem. For instance, the processor 204 can determine that 50 VROs in the first set are associated with bad fuel as the cause of a faulty fuel injector. Furthermore, the processor 204 can estimate a count of vehicles associated with the common vehicle descriptor that are located in the first geographic area during the first time period. For example, the processor 204 can estimate, based on insurance information, that the number of 2004 Toyota Camrys located in Chicago in January 2015 is 5000. Accordingly, the processor 204 can calculate the baseline as a ratio of 50/5000=1/500. The baseline can also be represented as a percentage or in decimal form, e.g., 1% or 0.01.

In a second embodiment, the baseline can be a ratio of the quantity of VROs in the first set associated with the common VSP to a count of vehicles associated with the first vehicle descriptor that were repaired, during the first time period, in a repair shop located in the first geographic area. Accordingly, similar to the previous embodiment, the processor 204 can determine that 50 VROs in the first set are associated with bad fuel as the cause of a faulty fuel injector. However, in this embodiment, the processor 204 can determine a count of 2004 Toyota Camrys that were serviced during January 2015 in repair shops located in Chicago. This number can also be the total number of VROs in the first set, which in this example, can be 200. The processor 204 can then calculate the baseline as 50/200=¼. The baseline can also be represented as a percentage or in decimal form, e.g., 25% or 0.25.

At block 506, the method 500 includes determining a comparison element based on a quantity of VROs in the second set including the common VSP. In particular, the processor 204 can analyze the VROs in the second set in order to determine the VROs that are associated with the common VSP that was used to determine the baseline.

In the first embodiment, the comparison element can be a ratio of the quantity of VROs in the second set associated with the common VSP to an estimate count of vehicles associated with the common vehicle descriptor located in the second geographic area during the second time period. Continuing with the example above, the processor 204 can determine that a plurality of VROs in the second set are associated with bad fuel as the cause of a faulty fuel injector. The processor 204 can then determine that 100 VROs in the second set are associated with the common VSP. Then, the processor 204 can estimate a count of vehicles associated with the common vehicle descriptor that are located in the second geographic area during the second time period. The processor 204 can then estimate, based on insurance information, that the number of 2004 Toyota Camrys located in Chicago in January 2016 is 4000. Accordingly, the processor 204 can determine that the comparison element is a ratio of 150/4000=1/30. The comparison element can also be represented as a percentage or in decimal form, e.g., 3.33% or 0.0333.

In the second embodiment, the comparison element can be a ratio of the quantity of VROs in the second set associated with the common VSP to an estimate count of vehicles associated with the common vehicle descriptor that were repaired, during the second time period, in a repair shop located in the second geographic area. Accordingly, similar to the first embodiment, the processor 204 can determine that one hundred fifty VROs in the second set are associated with bad fuel as the cause of a faulty fuel injector. However, in this embodiment, the processor 204 can determine a count of 2004 Toyota Camrys that were serviced in January 2016 in repair shops located in Chicago. This number can also be the total number of VROs in the second set, which in this example, can be three hundred. The processor 204 can then determine the comparison element as 150/300=½. The baseline can also be represented as a percentage or in decimal form, e.g., 50% or 0.5.

At block 508, the method 500 includes determining a deviation between the baseline and the comparison element. For instance, determining a deviation between the baseline and the comparison element can include comparing the comparison element to the baseline. The deviation can be a difference, a percent difference, percent change, relative percentage difference, or any other measure of deviation or difference between two values.

As an example, the processor 204 can compare the baseline and the comparison element that were calculated as part of the first embodiment described above. As such, the comparison element of 0.033 can be compared to the baseline of 0.01. The processor 204 can determine that the difference between the comparison element and baseline is 0.0233. Additionally and/or alternatively, the processor 204 can determine that the percent change from the baseline to the comparison element is 230%.

As another example, the processor 204 can compare the baseline and the comparison element that were calculated as part of the second embodiment described above. As such, the comparison element of 0.5 can be compared to the baseline of 0.25. The processor 204 can determine that the percent change from the baseline to the comparison element is 100%.

At block 510, the method 500 includes determining the deviation exceeds a threshold. The processor 204 can determine the deviation exceeds the threshold by comparing the calculated deviation to the threshold. In some examples, the threshold can be predetermined and/or can be constant. In other examples, the threshold can depend on the type of calculation performed. For instance, each of the embodiments described above can have a different threshold. In other examples, the predetermined threshold can depend on factors such as the detected common VSP and/or the common vehicle descriptor.

As an example, in the first embodiment described above, the deviation can be the percent change from baseline to the comparison element, and thus the threshold can be a percentage. In this example, the threshold can be 30%. Accordingly, the processor 204, when comparing the deviation to the threshold, can determine that the deviation of 230% exceeds the threshold of 30%. Similarly, in the second embodiment, the threshold can be 25%. The processor 204 can compare the deviation of 50% to the threshold of 25% and can determine that the deviation exceeds the threshold.

Further, at block 510, the method 500 includes responsively determining one or more common factors associated with at least a subset of the second set, wherein the one or more common factors are different than the common vehicle descriptor and the common VSP. The processor 204, after determining that the deviation exceeds the threshold, can analyze the VROs in the second set in order to determine a possible cause for the deviation from the baseline. In an example, the processor 204 can analyze the VROs in the second set in order to detect one or more common factors among at least a subset of the VROs in the second set.

The processor 204 can determine the common factor by searching the VRO data of each VRO included in the first set. Note that as common vehicle descriptor and the common VSP are (by definition) common amongst VROs in the subset, the common factor that is determined may not be the common VSP or the common vehicle descriptor.

In some examples, the common factors can include common data found in the VROs. Additionally and/or alternatively, the common factors can be determined from third party data associated with VROs in the second set. Examples of common factors include common VSPs, common locations, common fuel suppliers, common weather conditions, common geographical conditions, common part suppliers, etc.

In some examples, the common factor can be indicative of information that may not be apparent to a user or mechanic as the mechanic may not be aware of vehicle repairs that are occurring at other repair shops. The common factor can be indicative of a cause of a particular vehicle problem. It can also be indicative of a cause or result of a trend of malfunctioning of a particular vehicle type or a particular vehicle part type. For example, the common factor can indicate information or data that the manufacturer of the vehicle or of the particular part needs to be aware of in order to remedy a particular problem.

Continuing with the example introduced above, the processor 204 can determine that the one hundred fifty VROs that are associated with a faulty fuel injector as a result of bad fuel are also all associated with a common zip code in Chicago. The processor 204 can then determine that bad fuel can be a problem in the common zip code.

At block 512, the method 500 includes outputting a notification indicative of the common vehicle descriptor, the deviation, the common VSP, and the one or more common factors. The notification can be in the form of an alert on an operating computer, an email, a text-message, an automated phone-call, or any other form of communication. The notification can be directed to an operator of the ROS 200, to the vehicle manufacturer, and/or to a vehicle part manufacturer, or any other relevant party. The notification can also be directed to the repair tools located in repair shops such that the mechanics operating the RSEs can receive the notification.

Continuing with the example above, the processor 204 can send a notification to the repair shops that are located in the common zip code. The notification can be indicative of the common vehicle descriptor 2004/Toyota/Camry, the deviation (230% in the first embodiment, and 50% in the second embodiment), the common cause of the fuel injector malfunctions, and the common zip code. The notification can also include other data. For instance, the notification can also be indicative of fuel suppliers that supply fuel to gas stations located in the common zip code.

The example method provided in FIG. 5 and the accompanying description herein is for illustrative purposes only and should not be considered limiting. In an implementation, the first set of VROs and the second set of VROs can be generated such that both VRO sets include a specific quantity of VROs. In this implementation, the first set of VROs and the second set of VROs can each include the same quantity of VROs, but not all of the VROs in the two sets can be identical.

In an implementation of method 500, the baseline can be calculated as a ratio of a quantity of VROs associated with (i) a common vehicle descriptor, (ii) common VSP, (iii) a particular mileage range, and (iv) a first time period to a quantity of VROs associated with (i) the common vehicle descriptor, (ii) the particular mileage range, and (iii) the first time period. In another implementation, the baseline can be calculated as a ratio of a quantity of VROs associated with (i) a common vehicle descriptor, (ii) geographic areas outside a first geographic area, (iii) common VSP, and (iv) a first time period to a quantity of VROs associated with (i) the common vehicle descriptor, (ii) geographic areas outside the first geographic area, and (iii) the first time period. This baseline can be compared to a comparison element that is calculated to a ratio of a quantity of VROs associated with (i) a common vehicle descriptor, (ii) the first geographic area, (iii) the common VSP, and (iv) the first time period to a quantity of VROs associated with (i) the common vehicle descriptor, (ii) the first geographic area, and (iii) the first time period. The processor 204 can perform this comparison in order to determine any common factors unique that can be unique to the first area.

In another implementation, the processor 204 can perform the method 500 in response to a baseline trigger, such as the baseline triggers stored in baseline triggers 226. In yet another implementation, the processor 204 can periodically perform the method 500 at specific time intervals. The baselines and the comparison elements that are generated at each interval can be stored as data points. Thus, at a given interval, a comparison element can be compared to one of the previously generated baselines (which include previously generated comparison elements). Additionally and/or alternatively, the comparison element can also be compared to an average or mean of the previously generated baselines, a moving average of previously generated baselines, or a cumulative moving average of previously generated baselines. Other examples are also possible.

In an example, the processor 204 can be configured to periodically perform the method 500 every 7 days. As such, every 7 days, the processor 204 can determine a first set of a plurality of VROs and a second set of a plurality of VROs. The processor 204 can then use the first set and the second set to generate a baseline and a comparison element respectively. In some examples, the comparison element can be a previously generated baseline. For instance, and with reference to FIG. 4 and Table 3, the processor 204 can detect a deviation by comparing the baseline for baseline A to a comparison element that can include a baseline for any other 7-day baseline depicted in FIG. 4. Comparing the baseline A with any of baselines B, C or E would result in processor 204 detecting no deviation. Comparing the baseline A with any of baseline D or F would result in processor 204 detecting a downward deviation. Comparing the baseline A with any of the baselines G though Y, inclusive, would result in processor 204 detecting an upward deviation.

Detecting a deviation can include determining that the first or other deviation exceeds a deviation threshold. For example, if the deviation threshold is 25% and the baseline is 0.08, then any comparison element determined to exceed 0.1 (i.e., 0.08×1.25) can be considered a deviation. As another example, if the deviation threshold is 350% and the baseline is 0.08, then any comparison element determined to exceed 0.28 (i.e., 0.08×3.5) can be considered a deviation. As yet another example, if the deviation threshold is −25% and the baseline is 0.08, then any comparison element determined to be less than 0.06 can be considered a deviation.

In yet another implementation, the processor 204 can determine a velocity repairs that are associated with a common vehicle descriptor and/or a common VSP. In order to determine the velocity of repairs, the processor 204 can periodically generate a VRO set that includes VROs associated with the common vehicle descriptor and/or the common VSP. At each period (excluding the first period), the processor 204 can compare the number of VROs in the set to the number of VROs in the set at a previous period. The processor 204 can then, based on the comparison, determine a velocity of repair associated with the common vehicle descriptor and/or the common VSP.

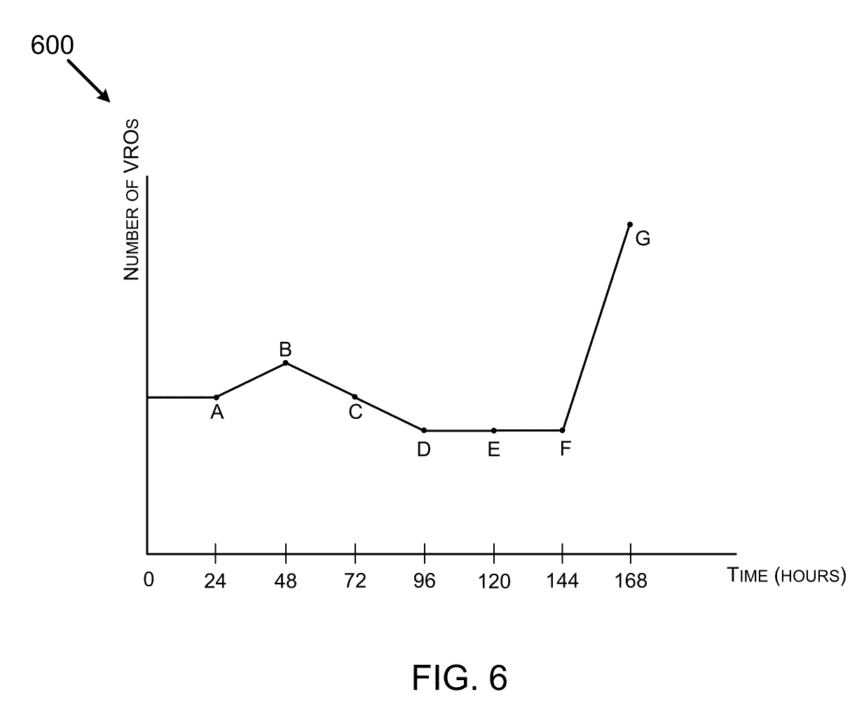

FIG. 6 illustrates a number of VROs plotted on a graph 600, according to an exemplary embodiment. In particular, the number of VROs plotted at each period illustrates the number of VROs received since the last period (and not the total number of VROs received since time=0). As illustrated in FIG. 6, the number of VROs at each period is labeled with an identifier. Furthermore, in order to determine a velocity of repairs at a particular period, the processor 204 can compare the number of VROs at that period to a number of VROs at a previous period.

As illustrated in FIG. 6, value A is indicative of a quantity of VROs that were generated between hours 0 and 24 and are associated with a common vehicle descriptor. For example, the processor 204 can determine that there are 20 vehicles associated with the common complaint (e.g., faulty were repaired fuel injector) and the common vehicle descriptor that were repaired, during the hours 0-24, in repair shops located in the first area.

At hour 48, the processor 204 can determine a value B that is a quantity of VROs that were generated between hours 24 and 48. For example, during the hours 24-48 there may have been 25 repairs of vehicles that are associated with the common complaint (e.g., faulty fuel injector) and that are associated with the common vehicle descriptor. The processor 204 can then calculate the velocity of the repairs. In particular, the repair velocity can be indicative of the rate of change (over a period of time) in the number of repairs performed of a particular vehicle type and/or vehicle part. In this example, the processor 204 can calculate the velocity as (25 repairs-20 repairs)/(24)=0.21 repairs/hr.

The processor 204 can then perform similar calculations every 24 hours. For example, at hour 72, the processor 204 can calculate the velocity of the repairs between hours 48 and 72. The calculated velocity can be compared to any other previously determined velocity. Additionally and/or alternatively, the calculated velocity can be compared to velocities calculated based on previous values. For instance, the calculated velocity between hours 48 and 72 can be compared to an average velocity between hours 0 and 48.

At hour 168, the processor 204 can also calculate the velocity of the vehicle repairs as (400−15)/(24)=16.04 repairs/hr. The processor 204 can then compare the velocity to a previously determined velocity or to a mean of all of the previously determined velocities. For instance, the processor 204 can compare the velocity 16.04 repairs/hour to 0.21 repairs/hour (e.g., the velocity of repairs between hours 24 and 48). Based on the comparison, the processor 204 can detect a spike in the velocity by determining that a deviation between the two velocities is greater than a threshold.

Responsive to detecting the spike, the processor 204 can further analyze the VROs included in the VRO set that was used to calculate the baseline G. As explained above, the processor 204 can analyze both the VROs and third party data in order to detect any common factors between the VROs in the VRO set that was used to calculate the baseline G. The processor 204 can then infer, based on the common factors, a cause of the spike in the velocity of repairs. Finally, the processor 204 can output a notification indicative of the spike.

A variety of methods including one or more other functions was discussed above with respect to the method 500. The following discussion provides examples of the one or more other functions. Each of these examples is referred to as “another function related to the method 500,” or “other functions related to the method 500.”

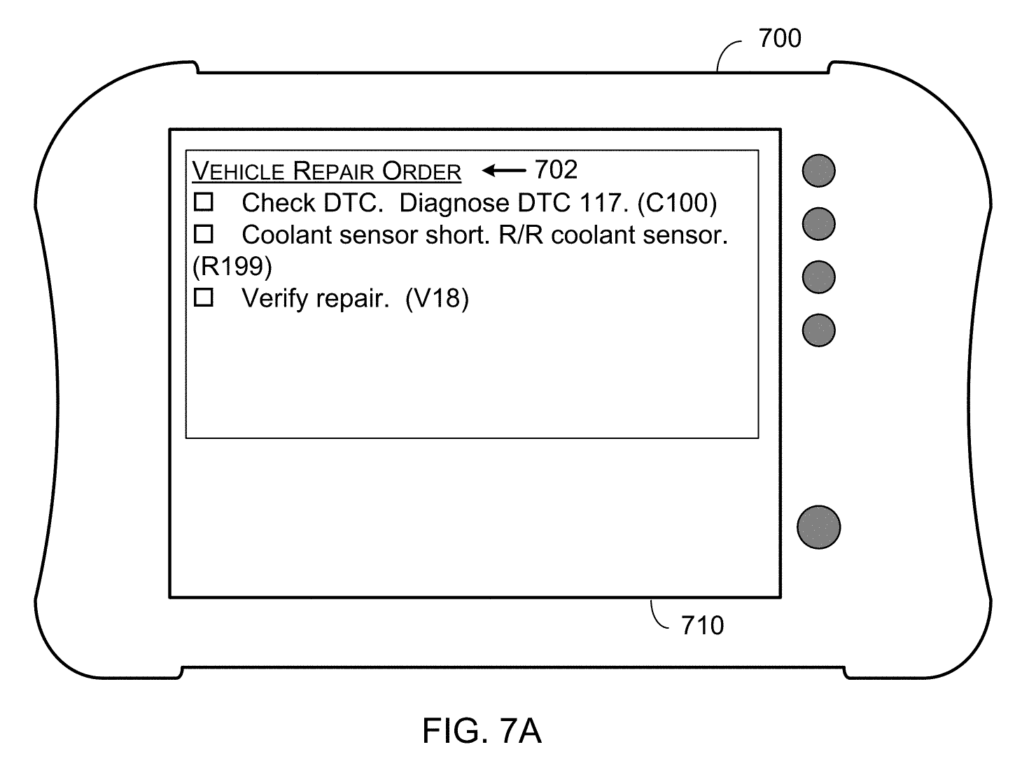

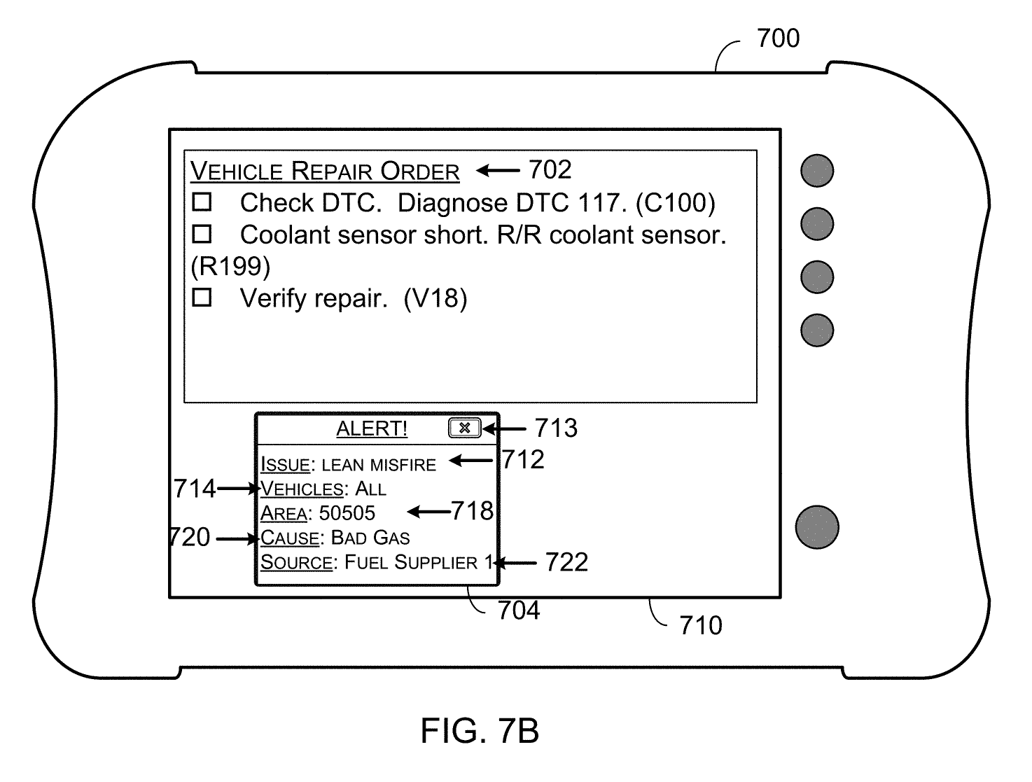

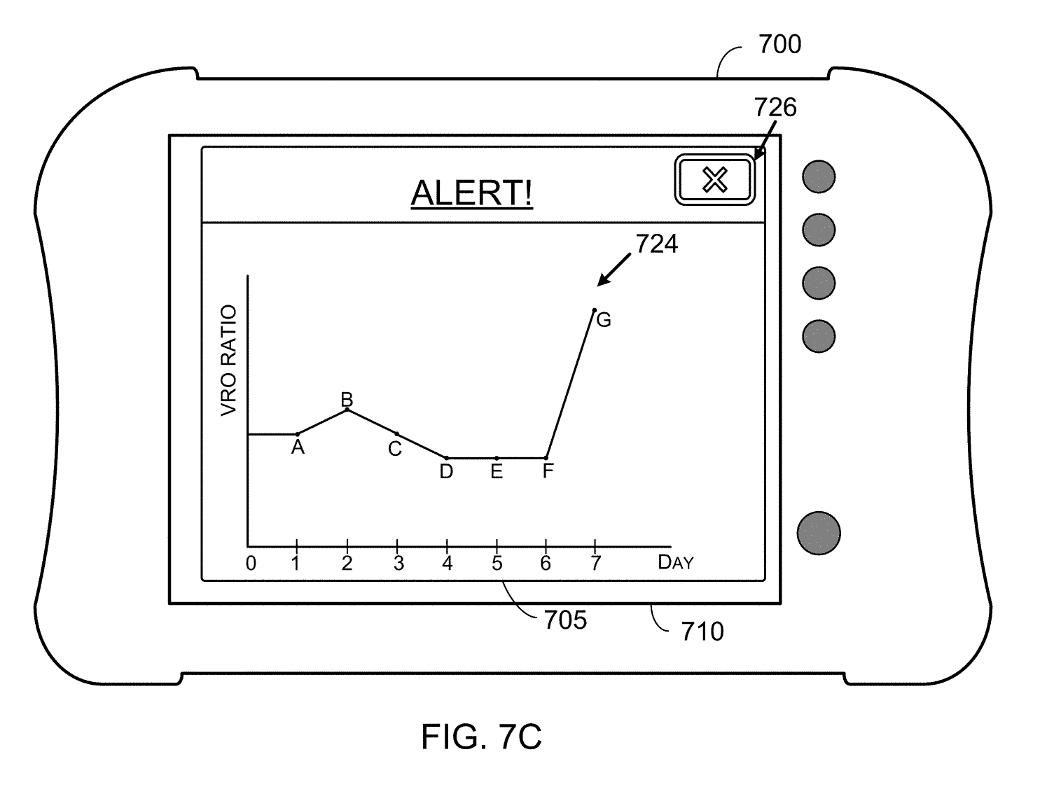

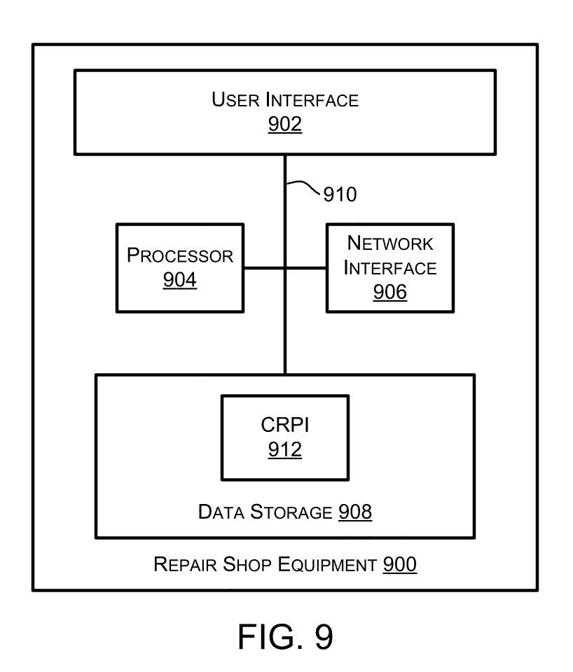

Another function related to the method 500 can include presenting the notification. Presenting the notification can include visually presenting the notification by a display device or other user interface component. FIGS. 7A-7C illustrate an example display device 700 visually presenting the notification. It is noted that FIGS. 7A-7C are shown for exemplary purposes only and are not meant to be limiting. In particular, the display device 700 can comprise or be configured as an RSE, such as an RSE 900 shown in FIG. 9, however, other display devices are possible.

FIG. 7A illustrates the display device 700, according to an exemplary embodiment. As explained above, the display device 700 can be located in a repair shop, and can be used to generate a VRO 702. For example, as shown in FIG. 7A, the display device 700 can display service procedure that are being carried out on a given vehicle. Other types of information can be displayed on the RSE 700 prior to or as the display device 700 receives a notification of a detected vehicle problem.

In an embodiment, the display device 700 can receive and display a notification from a server (e.g., ROS 200). The notification can be indicative of a detected vehicle problem. In particular, the notification can indicate the detected vehicle problem, a vehicle descriptor of the vehicles affected by the problem, a cause of the problem, among other data. For instance, the notification can also indicate fuel suppliers that supply fuel to gas stations located in a common zip code where the problem was detected.

FIG. 7B illustrates a notification window 704 displayed on the display device 700, according to an exemplary embodiment. As illustrated in FIG. 7B, the notification window 704 can be a “pop-up” window that is displayed in the display window 710 as the technician is using the display device 700 (e.g., to generate a VRO). As illustrated in FIG. 7B, the notification window can display a notification that is indicative of a vehicle problem. In particular, the notification window can display data indicative of a vehicle problem (issue) 712, a vehicle descriptor of the vehicles affected 714, a geographical area 718, a cause 720, and a source of the problem 722. In the example illustrated in FIG. 7B, the issue 712 is lean misfire, the vehicles 714 are all vehicles, the area is zip code 50505, the cause is bad gas, and the source is fuel supplier 1 (that supplies fuel to zip code 50505). This information indicates to the user that there is a spike in the number of vehicles with engine misfires in zip code 50505, and that a possible cause is bad fuel supplied by Fuel Supplier 1. Other types of information can be included in the notification window 704. In some examples, the technician using the display device 700 can request more information about the issue 712. In response, the display device 700 can display the data (or a representation of the data) that was used to detect the spike.

FIG. 7C illustrates a graph 724, displayed with a notification window 705, of VRO ratios over a period of 7 days, according to an exemplary embodiment. In particular, the display device 700 displays the graph 724 in response to the user requesting more information about the issue 712. The graph 724 is indicative of a ratio, for each day of the past 7 days, of VROs associated with engine misfires and a total number of VROs. As illustrated in FIG. 7C, there is a significant increase from the ratio F to the ratio G. This may illustrate to the technician that there was a significant increase over the past 24 hours in the vehicles that had an engine misfire. Other graphs and data may be displayed to the user. For instance, the graph 600 in FIG. 600 may be displayed to the user.

The display device 700 can display a cancel selector 713 in the notification window 704. A processor of the display device 700 can receive input indicate selection of the cancel selector 713 is occurring or has occurred and responsively remove the notification window 704 from the display window 710. As an example, upon removing the notification window 704, the display window 710 can appear as it did prior to displaying the notification window 704 (e.g., the display window can appear as shown in FIG. 7A).

The display device 700 can display a cancel selector 726 in the notification window 705. A processor of the display device 700 can receive input indicate selection of the cancel selector 726 is occurring or has occurred and responsively remove the notification window 705 from the display window 710. As an example, upon removing the notification window 705, the display window 710 can appear as it did prior to displaying the notification window 704 (e.g., the display window 710 can appear as shown in FIG. 7A) or as it did prior to the user requesting more information about the issue 712 (e.g., the display window 710 can appear as shown in FIG. 7B).

As shown in FIGS. 7B and 7C, the display device 700 can display a notification window of varying sizes within a display window 710 having a fixed size. A processor of the display device 700 can receive an input to change the size of a notification window or to zoom in or zoom out to change a size of information displayed within a notification window.

An input to request the display device 700 or an RSE comprising the display device 700 to display more information about the issue 712 or to select the cancel selector 713 or 726 can comprise an input via a touch screen display of the display device 700. Other functions related to the method 500 can include storing a first threshold for detecting the first deviation, and detecting a second ratio of a second number of repairs to fix the common symptom of the vehicles of the first vehicle type and a second number of the vehicles of the first vehicle type serviced. Data storage device 210 can store the first threshold within baseline deviation thresholds 228. Processor 204 can execute CRPI 220 to detect the second ratio based on the modified first VSR data. Processor 204 can detect the first deviation by detecting that the first ratio and the second ratio differ by at least the first threshold. For these other functions, the first ratio can include a ratio of a first number of repairs to fix a common symptom of the vehicles of the first vehicle type and a first number of the vehicles of the first vehicle type serviced.

Yet another function related to the method 500 can include presenting data or information that could be pertinent to the detected deviation. For instance, the data or information could be a diagnostic list that could be used to diagnose or service a vehicle that may be affected by the problem indicated by the deviation. Examples of a diagnostic list include a parameter identifier (PID) list, a component test list, a functional test list, and/or a reset procedure list. A diagnostic list could be stored in the ROS, and could be associated with one or more of the common vehicle descriptor, the common VSP, and the one or more common factors. As such, a diagnostic list can be applicable to a set of vehicles and a symptom exhibited by a vehicle within the set of vehicles.

In an embodiment, the processor 204 of the ROS could send a notification to a diagnostic tool, e.g., the RSE 900, responsive to detecting a deviation. In addition to a notification of the deviation, the notification could also include one or more diagnostic lists associated with the deviation. A diagnostic list is associated with the deviation if it is associated with a common vehicle descriptor, a common VSP, or common factor with which the deviation is associated. The one or more diagnostic lists associated with the deviation could be indicative of how to diagnose or repair a vehicle that may be affected by the issue indicated by the deviation. By way of example, a notification that is displayed on a diagnostic tool could indicate to a technician that a deviation has been detected, and could provide the technician with an option to view one or more diagnostic lists that are associated with the deviation. The technician could choose to view the one or more diagnostic lists or could choose to ignore the notification and continue servicing the vehicle. In some examples, a diagnostic list is sent to a diagnostic tool only if a vehicle that is currently being serviced by the diagnostic tool is a vehicle that is affected by an issue indicated by the deviation.

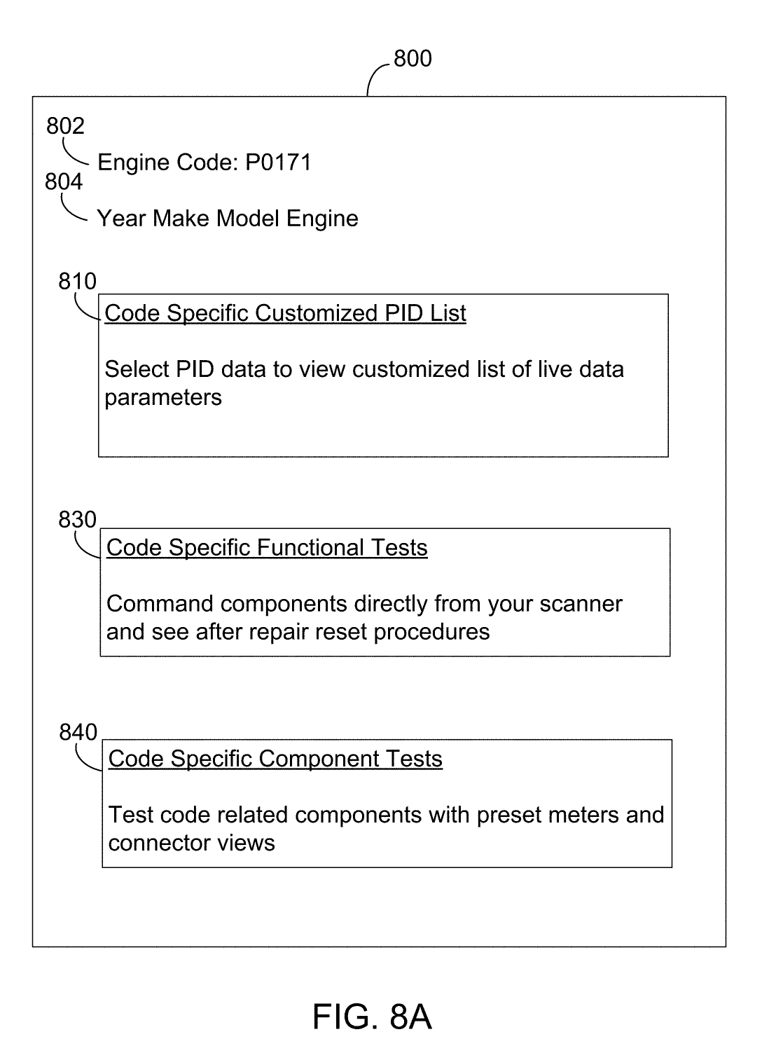

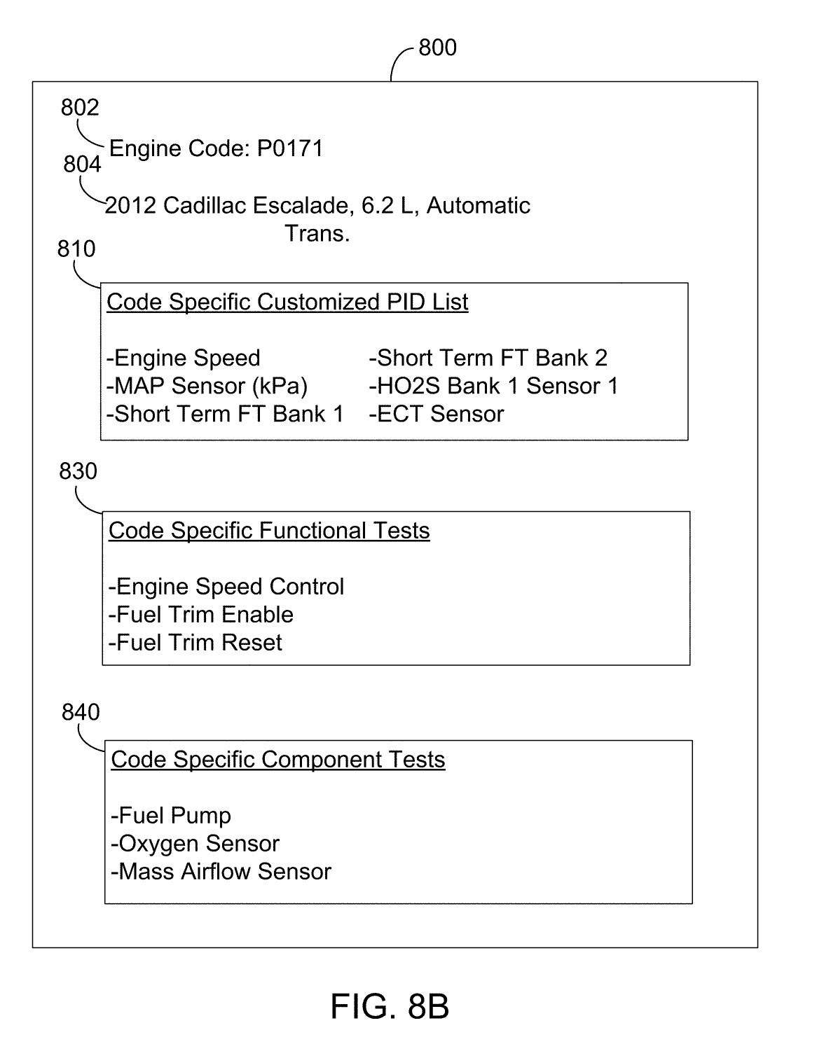

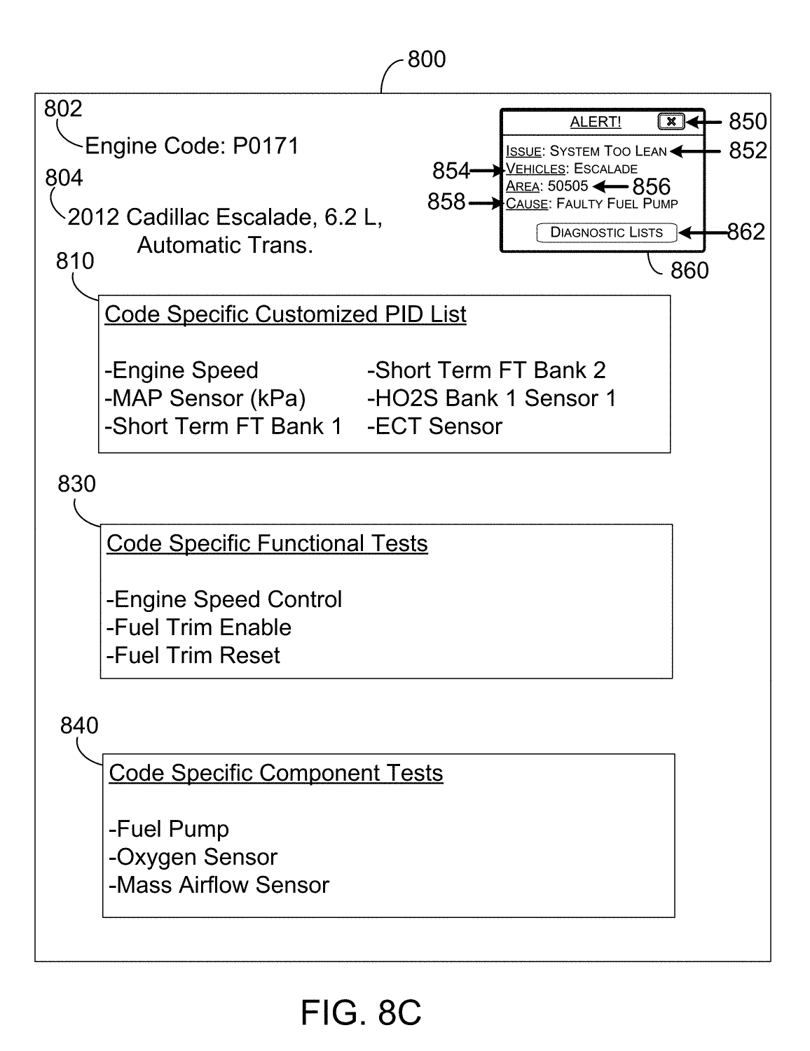

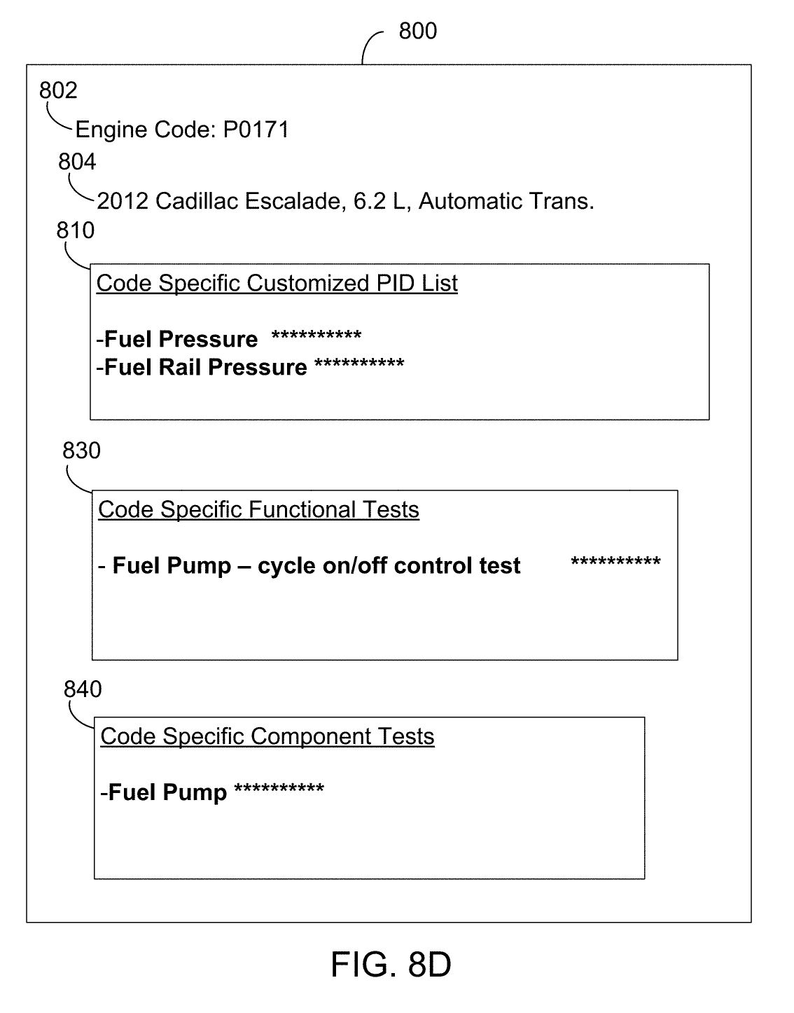

FIG. 8A shows an example display interface that could display a diagnostic list. In particular, the display interface may be part of a diagnostic tool that is being used to diagnose a vehicle. In an example, the display interface 800 can be part of the RSE 900. In other examples, the display interface 800 can be communicatively coupled to the RSE 900. In some examples, input data may be entered via display interface 800 with one or more input devices, such as a mouse, keyboard, or microphone. In another example, display interface 800 may be a touch-based interface.

The display interface 800 can display identifying information 804 about a vehicle that is being serviced. The identifying information 804 may include a year, make, model, and engine as displayed in FIG. 8A. In additional examples, the identifying information 804 may include different types of vehicle information as well or instead. The identifying information 804 may be received by the RSE 900 directly from a vehicle. In other examples, the identifying information 804 may be received in another manner, such as through user input via display interface 800.

Display interface 800 may additionally include an indication of at least one symptom identifier 802. The at least one symptom identifier 802 may include a single DTC, such as engine code P0171. In other examples, the at least one symptom identifier 802 may include two or more DTCs. In further examples, the at least one symptom identifier 802 may include a different type of symptom identifier as well or instead. For instance, the at least one symptom identifier 802 may be entered via display interface 800 or a different user interface. In another example, the at least one symptom identifier 802 may be captured from a repair order. Different information may be displayed on display interface 800 depending on the current state of display interface 800.

Display interface 800 may additionally include one or more information cards 810, 830, and 840. Each of the information cards 810, 830, and 840 may be selectable via display interface 800. In some examples, selection of an information card may cause the card to switch to a dynamic mode in which live data captured from a vehicle is displayed. In further examples, a display interface may include different or additional information cards than those displayed in FIG. 8A.

Display interface 800 includes PID card 810, which may be used to show a code-specific customized PID list. In particular, card 810 may display a subset of PIDs that are selected from a set of available PID's based on the at least one symptom identifier 802. As shown in FIG. 8A, PID card 810 may be selected in order to view a customized list of PIDs with live PID data.

Display interface 800 additionally includes functional test card 830, which may be used to show a code-specific list of functional tests. In particular, functional test card 830 may display a subset of functional tests that are selected from a set of available functional tests based on the at least one symptom identifier 802. As shown in FIG. 8A, the functional test card 830 may provide functional tests which allow vehicle components from the vehicle to be commanded directly from the RSE 900. In some examples, the functional test card 830 may additionally display one or more code-specific reset procedures, which may be performed after one or more repair operations are completed. In additional examples, a separate reset procedure card may be provided within a display interface in order to display code-specific reset procedures.

Display interface 800 additionally includes component test card 840, which may be used to show a code-specific list of component tests. In particular, component test card 840 may display a subset of component tests that are selected from a set of available component tests based on the at least one symptom identifier 802. As shown in FIG. 8A, component test card 840 may provide component tests which allow for the testing of code-related components with preset meters and connector views. More specifically, selection of a component test within display interface 800 may cause the RSE 900 to provide instructions to an oscilloscope or a multimeter which is connected to the vehicle in order to perform the selected component test on a component of the vehicle.

Next, FIG. 8B shows an example display interface of a diagnostic tool that is being used to diagnose a 2012 Cadillac Escalade with a 6.2 L engine and an automatic transmission. In particular, the display interface displays information cards 810, 830, and 840. PID card 810 displays a symptom-based subset of PIDs, functional test card 830 displays a symptom-based subset of functional tests and reset procedures, and component test card 840 displays a symptom-based subset of component tests.

PID card 810 displays a code-specific customized PID list which includes six different PIDs. The six PIDs have six corresponding descriptors: Engine Speed, Short Term FT Bank 2, MAP Sensor (kPa), HO2S Bank 1 Sensor 1, Short Term FT Bank 1, and ECT Sensor. This symptom-based subset of PIDs may be determined by the RSE 900 based on a PID list provided from the ROS for the at least one symptom identifier 802. In one example, PID descriptors may be displayed when PID card 810 is in a static mode, but live PID data may not be displayed. When PID card 810 is selected via display interface 800, PID card 810 may be switched to a dynamic mode in which live PID data is displayed. In some examples, live PID data may be requested by the RSE 900 and received from the vehicle in response to selection of PID card 810 via display interface 800.

Functional test card 830 displays a code-specific functional test list which includes three different functional tests and reset procedures. The three functional tests and reset procedures have three corresponding descriptors: Engine Speed Control, Fuel Trim Enable, and Fuel Trim Reset. This symptom-based subset of functional tests and reset procedures may be received by the RSE 900 from the ROS for the at least one symptom identifier 802. In one example, when a particular functional test is selected from functional test card 830, a functional test may be initiated by a communication from the RSE 900 to the vehicle.

Component test card 840 displays a code-specific component test list which includes three different component tests. The three component tests relate to three different vehicle components: Fuel Pump, Oxygen Sensor, and Mass Airflow Sensor. This symptom-based subset of component tests may be determined by the RSE 900 based on a component test filter list from the ROS for the at least one symptom identifier 802. In one example, when a particular component test is selected from component test card 840, a component test may be initiated by a communication from the RSE 900 to a multimeter or an oscilloscope that is connected to the vehicle.

FIG. 8C illustrates a notification window 860 displayed on the display device, according to an exemplary embodiment. As illustrated in FIG. 8C, the notification window 860 can be a “pop-up” window that is displayed in the display interface 800 as the technician is using the display device (e.g., to diagnose a vehicle). As illustrated in FIG. 8C, the notification window can display a notification that is indicative of a vehicle problem. In particular, the notification window can display data indicative of a vehicle symptom (issue) 852, a vehicle descriptor of the vehicles affected 854, a geographical area 856, and a cause 858. In the example illustrated in FIG. 8C, the issue 852 is that the system is too lean, the vehicles 854 are Escalades, the area is zip code 50505, and the cause is a faulty fuel pump. This information indicates to the user that there is a spike in the number of Escalades in the zip code 50505 that have a lean condition, and that a possible cause of the issue is a faulty fuel pump. Other types of information can be included in the notification window 860. In some examples, the technician using the display device can request more information about the issue 852. In response, the display device can display the data (or a representation of the data) that was used to detect the spike.

By way of example, the technician could select the button 862 to request to view diagnostic lists associated with the deviation. Within examples, the processor 204 could send the diagnostic lists to the display device with the notification. In one example, after detecting the deviation, the processor 204 could identify any diagnostic tools that are diagnosing vehicles that have an issue or symptom indicated by the deviation, and could then send the notification and the diagnostic lists to those diagnostic tools. In another example, after detecting a deviation, the processor 204 could send a notification to all diagnostic tools, and could then send the diagnostic lists upon request from the diagnostic tool. The diagnostic lists that are sent to a diagnostic tool could identify information indicative of how to diagnose or repair a vehicle that has been affected by the issue indicated by the deviation. In the example illustrated in FIG. 8C, the issue that the system is too lean, and therefore the processor 204 could send one or more diagnostic lists that could help a technician diagnose or repair this issue. Within examples, the portions of the diagnostic lists that could be used to diagnose or repair the cause of the deviation could be highlighted by changing the color (e.g., to red) of the portions, providing an indicator, or otherwise distinguishing the portions.

Alternatively, the technician could select a cancel selector 850. The display device display the cancel selector 850 in the notification window 860. A processor of the display device can receive input indicate selection of the cancel selector 850 is occurring or has occurred and responsively remove the notification window 860 from the display interface 800. As an example, upon removing the notification window 860, the display interface 800 can appear as it did prior to displaying the notification window 860 (e.g., the display window can appear as shown in FIG. 8A).

FIG. 8D illustrates diagnostic lists displayed on a display window, according to an exemplary embodiment. In the example illustrated in FIG. 8D, the technician elected to receive diagnostic lists associated with the deviation by selecting the diagnostic lists button 862 (shown in FIG. 8C). As illustrated in FIG. 8D, each of the information cards 810, 830, and 840 has been updated. In particular, the updated information cards include information on how to diagnose or repair a vehicle that has an issue or symptom indicated by the deviation. In some examples, one or more of the information cards could be updated.

As illustrated in FIG. 8D, the PID card 810 has been updated to include two new PIDs: Fuel Pressure and Fuel Rail Pressure. Within examples, the diagnostic tool could use one or more of the PIDs to perform a PID test to help the technician diagnose the vehicle. In some implementations, the diagnostic tool could be configured to automatically perform the PID tests in response to the user selecting the diagnostic lists button 862 (shown in FIG. 8C). In other implementations, the technician could provide an input to the diagnostic tool that would cause the diagnostic tool to perform one or more PID tests.

As illustrated in FIG. 8D, the functional tests card 830 has been updated to include a new functional test: Fuel Pump—cycle on/off control test. Within examples, the diagnostic tool could perform a functional test to help the technician diagnose the vehicle. In some implementations, the diagnostic tool could be configured to automatically perform the functional test in response to the user selecting the diagnostic lists button 862 (shown in FIG. 8C). In other implementations, the technician could provide an input to the diagnostic tool that would cause the diagnostic tool to perform the functional test.

As illustrated in FIG. 8D, the component tests card 840 has been updated such that the Fuel Pump component test is highlighted, which could indicate to the technician to run the test in order to diagnose the vehicle in service. In some implementations, the diagnostic tool could be configured to automatically perform the component test in response to the user selecting the diagnostic lists button 862 (shown in FIG. 8C). In other implementations, the technician could provide an input to the diagnostic tool that would cause the diagnostic tool to perform the functional test.

In accordance with the description above, another function related to the method 500 can include performing a PID test. For instance, a diagnostic tool could perform a PID test. In particular, performing a PID test can include sending data messages to a vehicle in service (i.e., vehicle that is being diagnosed by the diagnostic tool), and in response, the vehicle could send a message to the diagnostic tool including the requested PID data. By way of example, the diagnostic tool could select a PID from a list of PIDs (e.g., PID card 810 in FIG. 8A), and could then send to the vehicle a data message indicative of the selected PID. And in response, the vehicle could send to the diagnostic tool PID data associated with the selected PID.

Also, in accordance with the description above, another function related to the method 500 can include performing a functional test. Similar to the PID test, the functional test could be performed by a diagnostic tool, and performing the test could include sending data messages to the vehicle under service. However, in a functional test, a vehicle responds to receiving a data message by controlling a component on the vehicle (e.g., turning the component on or off). By way of example, the diagnostic tool could select a function test from a list of functional tests (e.g., functional test card 830 in FIG. 8A), and could then send to the vehicle a data message indicative of the selected functional test. And in response, the vehicle could control a component as specified by the data message.

Also, in accordance with the description above, another function related to the method 500 can include performing a component test to diagnose and/or repair a vehicle. For instance, a component test could be performed by a diagnostic tool. In particular, performing a component test could involve the diagnostic tool testing code-related components with preset meters and connector views. For instance, performing a component test could involve providing instructions to an oscilloscope or a multimeter which is connected to the vehicle in service in order to perform the selected component test on a component of the vehicle. Within examples, a diagnostic tool could select the component test from a list of component tests (e.g., component test card 840 in FIG. 8A).

Another function related to the method 500 can include analyzing the data associated with VRO baseline ratios that have been generated over time. In particular, the VRO baseline ratios are calculated based on VRO sets that are associated with the same one or more common characteristics. For example, Table 4 lists VRO ratios associated with the same vehicle descriptor, same length of time, and the particular geographic location. That is, the system generated seven day baselines for vehicles associated with the same vehicle descriptor located in a particular geographic location. Other examples are possible. For instance, the VRO baseline ratios can be calculated based on VRO sets that are associated with the same vehicle descriptor and one or more geographic areas of similar size.

TABLE 4

| | | | | VRO Baseline |
|---|---|---|---|---|
| VRO | VRO | | | Ratio (Value): |
| Baseline | Baseline | VRO | No. of | VRO Quantity/ |
| ID | Type | Quantity | Vehicles | No. of Vehicles |
| A | 7-Day | 8 | 103 | 0.08 |
| B | 7-Day | 30 | 123 | 0.24 |
| C | 7-Day | 8 | 103 | 0.08 |
| D | 7-Day | 2 | 111 | 0.018 |
| E | 7-Day | 9 | 116 | 0.08 |
| F | 7-Day | 5 | 101 | 0.05 |
| G | 7-Day | 43 | 160 | 0.27 |
| H | 7-Day | 14 | 88 | 0.16 |
| I | 7-Day | 16 | 88 | 0.18 |
| J | 7-Day | 16 | 98 | 0.16 |
| K | 7-Day | 21 | 87 | 0.24 |
| L | 7-Day | 26 | 110 | 0.24 |
| M | 7-Day | 30 | 123 | 0.24 |
| N | 7-Day | 32 | 120 | 0.27 |
| O | 7-Day | 35 | 136 | 0.26 |
| P | 7-Day | 37 | 136 | 0.27 |
| Q | 7-Day | 37 | 136 | 0.27 |
| R | 7-Day | 37 | 162 | 0.23 |
| S | 7-Day | 37 | 162 | 0.23 |
| T | 7-Day | 43 | 160 | 0.27 |
| U | 7-Day | 45 | 163 | 0.28 |
| V | 7-Day | 47 | 158 | 0.29 |
| W | 7-Day | 47 | 158 | 0.29 |
| X | 7-Day | 47 | 158 | 0.29 |
| Y | 7-Day | 52 | 164 | 0.31 |

Another function related to the method 500 can include smoothing the VRO ratios to remove noise from the data. That is, smoothing the VRO ratios (baselines) can diminish the effect of anomalies on the data. For example, as listed in Table 4, the VRO baseline D may be a ratio with the value of 0.018. Compared to the other values in Table 4, the value of the ratio D is relatively low. Therefore, if a new VRO baseline (i.e., based on a recently generated VRO set) is compared to ratio D, a deviation can be detected. But if the new baseline is compared to another ratio (e.g., ratio Y), a deviation is not detected. Thus, two different results can occur based on the ratio to which the new VRO baseline is compared. A similar issue may occur if a ratio value is too high (i.e., a new baseline ratio compared to the high ratio may not result in a deviation being detected even if the new baseline ratio is indicative of a problem with the vehicles).

To prevent this issue from occurring, the VRO ratios can be smoothed to diminish the effect of data outliers (e.g., VRO baseline D in Table 4). In an example, smoothing the data can involve discarding VRO ratios that are two or more standard deviations from the mean of the VRO ratios. In another example, new VRO baselines can be compared to a mean of previously generated ratios. For instance, a new VRO baseline to be added to the Table 4 can be compared to the mean of the ratios A-Y (or any other combination of the ratios) in order to detect whether the new VRO deviates from the VRO ratio data. Other methods of data smoothing and filtering are possible. Examples include additive smoothing, filtering using a Butterworth filter, exponential smoothing, moving average smoothing, among others.

Another function related to the method 500 can include adjusting the deviation threshold. The deviation threshold could be adjusted in order to increase the accuracy of detecting a deviation. One way the threshold could be adjusted is by detecting that the calculated VRO ratio data over a period of time is smooth (i.e., the VRO ratios are comparable). The deviation threshold could then be calculated as a function of the average of the VRO ratios. For example, the deviation threshold could be the average of the VRO ratios added to a predetermined uncertainty value. The new deviation threshold could be greater than or less than the original deviation threshold. On the other hand, if there are large swings in the VRO ratio data, then the deviation threshold is not adjusted.

### V. Example Repair Shop Equipment

Next, FIG. 9 is a block diagram showing details of example repair shop equipment (RSE) 900. The RSE 900 includes a user interface 902, a processor 904, a network interface 906, and a data storage device 908, all of which can be linked together via a system bus, network, or other connection mechanism 910. One or more of the RSE shown in FIG. 1 can be arranged like RSE 900. RSE 900 can be arranged like one or more of RSE shown in FIG. 1.

The processor 904 can be configured to execute computer-readable program instructions, such as computer-readable program instructions (CRPI) 912 stored within data storage device 908. For purposes of this description, the processor 904 executing the CRPI 912 to perform some function described herein can comprise executing a portion of the CRPI 912 or the entirety of the CRPI 912. Executing a portion or the entirety of the CRPI 912 can include executing some of the computer-readable program instructions multiple times.

The data storage device 908 can comprise a non-transitory computer-readable storage medium readable by the processor 904. In an alternative arrangement, the data storage device 908 can comprise two or more non-transitory computer-readable storage mediums. Each non-transitory computer-readable storage medium can comprise volatile and/or non-volatile storage components, such as optical, magnetic, organic or other memory or disc storage, which can be integrated in whole or in part with a processor, such as the processor 904.

The user interface 902 can comprise an interface to components operable to enter data or information into the RSE 900 or to components that can present data or information output by the RSE 900. Those components can be referred to as RSE user interface components. The user interface 902 can include one or more audio/visual ports or communication ports that connect to an RSE user interface component by a wired or wireless user interface communication link. Data or information entered into the RSE 900 by the user interface 902 can include data or information for preparing a VRO, such as VRO 300.

The user interface 902 can include one or more of the RSE user interface components. As an example, the RSE user interface components can include an infrared remote control device, a display device, a loud speaker configured to convert electrical signals to audible sounds, a keyboard, a touch screen, a pointing device, such as a computer mouse, or some other component for generating signals to enter data or information into the RSE 900 or to present data or information output by the user interface 902. The user interface 902 can include a transmitter or transceiver to provide the data or information to another RSE user interface component. The data or information output by the RSE 900 can comprise data for displaying a service bulletin generated in response to the ROS 200 providing a notification identifying a deviation in VRO data detected by the processor 204.

The network interface 906 can comprise an interface to one or more communication networks, such as the network 104. For use with wireless communication networks, the network interface 906 can comprise one or more antennas for transmitting or receiving wireless communications. The network interface 906 can include one or more communication ports configured to connect to a wired communication link of a network. Examples of the wired communication link are listed elsewhere herein. The network interface 906 can include a network controller including a transmitter, a receiver, or a transceiver. The transmitter or transceiver can provide data or information to a communication port for transmission as network communications over the connected network. The receiver or transceiver can receive data or information received at a communication from the connected network. The data or information received by the network interface 906 can include a notification identifying a deviation in VRO data detected by processor 204. The data or information provided by network interface 906 to the network can include a VRO.

The CRPI 912 can comprise program instructions for generating a VRO, such as the VRO 300, based on data input by the user interface 902. The CRPI 912 can comprise program instructions for performing diagnostic functions for diagnosing a vehicle identified on a VRO. As an example, performing the diagnostic functions can include checking a diagnostic trouble code (DTC), such as a DTC 117, as identified in section 328 of the VRO 300.

### VI. Conclusion

Example embodiments have been described above. Those skilled in the art will understand that changes and modifications can be made to the described embodiments without departing from the true scope and spirit of the present invention, which is defined by the claims.

1. A method performed by a computing device, the method comprising:
determining a first set of multiple vehicle repair orders (VROs) and a second set of multiple VROs, wherein the VROs within the first and second sets are associated with a common vehicle descriptor indicative of a category of vehicles;
determining a vehicle service baseline based on a quantity of VROs in the first set including a common vehicle service phrase (VSP);
determining a comparison element based on a quantity of VROs in the second set including the common VSP;
determining a deviation between the baseline and the comparison element;
determining the deviation exceeds a threshold and responsively determining one or more common factors associated with at least a subset of the second set, wherein the one or more common factors are different than the common vehicle descriptor and the common VSP; and
outputting a notification indicative of the common vehicle descriptor, the deviation, the common VSP, and the one or more common factors.

2. The method of claim 1, wherein the common vehicle descriptor is indicative of at least one of: (i) a vehicle model, (ii) a vehicle mileage range, (iii) a vehicle manufacturer, (iv) a vehicle model year, and (v) a vehicle propulsion system.

3. The method of claim 1, wherein the common vehicle descriptor is indicative of a vehicle manufacturer and at least one of: (i) vehicle leveraging data indicating a vehicle model built by the vehicle manufacturer and at least two vehicle model years, and (ii) vehicle leveraging data indicating at least two vehicle models built by the manufacturer and at least one vehicle model year.

4. The method of claim 1, wherein each of the first and second sets is associated with at least one of: (i) a respective timeline, and (ii) a common quantity of vehicle repair orders.

5. The method of claim 1, wherein the common VSP is indicative of at least one of: (i) a cause of a vehicle problem, (ii) a correction of the vehicle problem, and (iii) a complaint indicative of the vehicle problem.

6. The method of claim 1, wherein the first set and the second set are associated with a first timeline and a second timeline respectively,
wherein the baseline comprises a first ratio of a first number indicative of the quantity of VROs in the first set including the common VSP and a second number indicative of an estimate count of vehicles with the common vehicle descriptor located in a first area during the first timeline, and
wherein the comparison element comprises a second ratio of a third number indicative of the quantity of VROs in the second set including the common VSP and a fourth number indicative of an estimate count of vehicles with the common vehicle descriptor located in a second area during the second timeline.

7. The method of claim 6, wherein the first timeline and the second timeline have equivalent durations starting on different calendar dates.

8. The method of claim 6, wherein the second number and the fourth number are based on respective insurance information, during the first timeline and second timeline respectively, of vehicles associated with the common vehicle descriptor.

9. The method of claim 6, wherein the first area and the second area are the same area.

10. The method of claim 6, wherein the first area and the second area are different areas, and wherein the estimate count of vehicles with the common vehicle descriptor located in the first area during the first timeline and the estimate count of vehicles with the common vehicle descriptor located in the second area during the second timeline are similar.

11. The method of claim 1,
wherein the first set is associated with a first timeline and includes VROs of respective sets of previously determined baselines in a first area, wherein each of the respective sets is associated with a respective timeline within the first timeline,
wherein each of the previously determined baselines comprises a first ratio of a first number indicative of a quantity of VROs in the respective set including the common VSP and a second number indicative of an estimate count of vehicles with the common vehicle descriptor located in the first area during the respective timeline,
wherein the baseline is a mean of the previously determined baselines, and
wherein the comparison element comprises a second ratio of a third number indicative of the quantity of VROs in the second set including the common VSP and a fourth number indicative of an estimate count of vehicles with the common vehicle descriptor located in a second area during a second timeline.

12. The method of claim 11, further comprising:
smoothing the previously generated baselines.

13. The method of claim 1,
wherein each of the first set and the second set is associated with a respective timeline,
wherein the baseline comprises a first ratio of a first number indicative of the quantity of VROs in the first set including the common VSP and a second number indicative of a count of all VROs in the first set, and
wherein the comparison element comprises a second ratio of a third number indicative of the quantity of VROs in the second set including the common VSP and a fourth number indicative of a count of all VROs in the second set.

14. The method of claim 1,
wherein each of the first set and the second set is associated with a common quantity of repair orders,
wherein the baseline comprises a number indicative of the quantity of VROs in the first set including the common VSP, and
wherein the comparison element comprises a number indicative of the quantity of VROs in the in the second set including the common VSP.

15. The method of claim 1, wherein at least one of the one or more common factors is based on third party data.

16. A non-transitory computer-readable medium storing:
a first set of multiple vehicle repair orders (VROs) and a second set of multiple VROs, wherein the VROs within the first and second sets are associated with a common vehicle descriptor indicative of a category of vehicles; and
program instructions executable by a processor to perform or cause performance of operations including:
determining a vehicle service baseline based on a quantity of VROs in the first set including a common vehicle service phrase (VSP);
determining a comparison element based on a quantity of VROs in the second set including the common VSP;
determining a deviation between the baseline and the comparison element;
determining the deviation exceeds a threshold and responsively determining one or more common factors associated with at least a subset of the second set, wherein the one or more common factors are different than the common vehicle descriptor and the common VSP; and outputting a notification indicative of the common vehicle descriptor, the deviation, the common VSP, and the one or more common factors.

17. The non-transitory computer-readable medium of claim 16, wherein the first set and the second set are associated with a first timeline and a second timeline respectively,
wherein the baseline comprises a first ratio of a first number indicative of the quantity of VROs in the first set including the common VSP and a second number indicative of an estimate count of vehicles with the common vehicle descriptor located in a first area during the first timeline, and
wherein the comparison element comprises a second ratio of a third number indicative of the quantity of VROs in the second set including the common VSP and a fourth number indicative of an estimate count of vehicles with the common vehicle descriptor located in a second area during the second timeline.

18. A system comprising:
a processor; and
a non-transitory computer-readable data storage device storing a first set of multiple vehicle repair orders (VROs) and a second set of multiple VROs, wherein the VROs within the first and second sets are associated with a common vehicle descriptor indicative of a category of vehicles, and storing computer-readable program instructions,
wherein the computer-readable program instructions are executable by the processor to:
determine a vehicle service baseline based on a quantity of VROs in the first set including a common vehicle service phrase (VSP);
determine a comparison element based on a quantity of VROs in the second set including the common VSP;
determine a deviation between the baseline and the comparison element;
determine the deviation exceeds a threshold and responsively determine one or more common factors associated with at least a subset of the second set, wherein the one or more common factors are different than the common vehicle descriptor and the common VSP; and outputting a notification indicative of the common vehicle descriptor, the deviation, the common VSP, and the one or more common factors.

19. The system of claim 18, further comprising a transceiver configured to transmit the notification.

20. The system of claim 18, wherein the transceiver is configured to receive a plurality of VROs, including the multiple VROs of each of the first set and second set, for subsequent storage within the data storage device.
